(19) United States
(12) Patent Application Publication
(10) Pub. No.: US 2003/0195838 A1
(43) Pub. Date: Oct. 16, 2003

(54) Method and system for provision and acquisition of medical services and products

(76) Inventor: Julian L. Henley, Guilford, CT (US)

Correspondence Address: NIXON & VANDERHYE, PC, 1100 N GLEBE ROAD, 8TH FLOOR, ARLINGTON, VA, 22201-4714, US

(21) Appl. No.: 10/420,869

(22) Filed: Apr. 23, 2003

Related U.S. Application Data
(63) Continuation-in-part of application No. 09/725,142, filed on Nov. 29, 2000.

(51) Int. Cl. G06F 17/60

(52) U.S. Cl. 705/37; 705/2; 705/14

(57) ABSTRACT

Transactional costs associated with providing professional services are reduced by enabling prospective clients/patients and professional service providers to competitively negotiate fees for proffered services through an interactive on-line professional services auction transaction system implemented over a publicly accessible communications network such as the Internet. A separate on-line auction transaction system, which shares database resources with the professional services auction transaction system, is also provided for implementing an arrangement for auctioning options to purchase services at a discount—such as discount coupons that are applicable toward fees charged for proffered professional services. A person-to-person network marketing arrangement for rewarding existing member professional service providers for recruiting prospective new service provider members and training them in the use of the on-line auction transaction systems is also fostered and supported via the on-line professional services auction transaction system.

### RELATED APPLICATIONS

This application is a continuation-in-part of parent U.S. patent application Ser. No. 09/725,142, filed Nov. 29, 2000, which is hereby incorporated by reference herein.

### FIELD OF THE INVENTION

The present invention generally relates to a method and system for implementing an electronic on-line auction of professional services and products via the Internet. More particularly, the present invention relates to a business model method and apparatus for reducing transactional costs associated with professional services and/or facilitating the selection process for obtaining professional services and products such as medical services.

### BACKGROUND OF THE INVENTION AND RELATED ART

During the advent of a booming e-commerce over the Internet, many people have become familiar with the flexibility and cost effectiveness of shopping “on line” for various goods via the use of Internet sites that offer public auctioning forums of one sort or another where sellers and buyers may participate in some form of interactive bidding process. However, while on-line auctioning has been employed somewhat successfully in the context of bartering for various products, problems arise when trying to accommodate the need for assessing professional service provider qualifications, scheduling, location and quality. One of the problems confronting an on-line bidder for professional services is that there is no readily convenient means for verifying the qualifications of an otherwise unknown service provider or for assessing the quality of services likely to be rendered by a particular provider.

On-line auction systems are known to have been attempted for only a limited few types of professional services. For example, U.S. Pat. No. 6,006,191 to DiRienzo (1999) discloses a system wherein certain limited medical services of remote physicians' are auctioned, to wit, DiRienzo is specifically directed toward the reading of radiological and other medical images (i.e., image-reading diagnostic services). In this context, DiRienzo generally teaches:

“ . . . The essence of the invention is the use of a decentralized, i.e., self-organizing, distribution system combined with bid queues to establish a market place which allows for continuously negotiated prices with control (over who reads the images, when they are read and what the fee will be for such a reading) being totally in the hands of the patient/gate keeper and the diagnostic physician.” [column 8, lines 31-37].

Additional prior art patents of possible interest include:

U.S. Pat. No. 5,918,208—Javitt (1999)

U.S. Pat. No. 5,964,700—Tallman et al (1999)

U.S. Pat. No. 5,995,939—Berman et al (1999)

U.S. Pat. No. 6,014,629—DeBruin-Ashton (2000)

U.S. Pat. No. 6,035,288—Solomon (2000)

Javitt is directed to a system that allows a doctor to forecast utilization of services. Tallman et al discloses an on-line system that allows an insurance company member to select the most appropriate doctor. Berman et al teaches an e-mail system between doctors and others involved in a specific patient's health care. DeBruin-Ashton teaches a method of compiling a customized directory of medical service providers for a particular patient. Solomon is generally directed to on-line bidding for a service (i.e., any service, medical or otherwise) in which the price can be negotiated.

More recently, an Internet “web”-site, having a URL (uniform resource locator) address of “HealthMarket.com”, has begun providing an on-line exchange for locating and comparing prices of proffered health care services/physicians. This web accessible facility purports to provide “an internet-based utility that allows employers, individuals, brokers and insurers to find, evaluate, purchase and finance healthcare insurance” but does not currently suggest or support on-line auctioning of personal medical services. There are also at least several well known on-line auction and reverse bidding systems such as eBay (eBay.com) and Priceline (priceline.com), but these systems also do not readily support or suggest an arrangement for the on-line auctioning of personal medical services. In addition, although several retailers currently make discount coupons for various proffered products/services available on line (e.g., retailers in the grocery, travel and hotel industries), there are currently no known analogous practices or on-line pricing arbitration services or facilities that offer such in the arena of personal health/medical services or other professional services. Moreover, there no known on-line systems which specifically accommodate the auctioning of discount coupons or options to purchase services at a discount and/or analogous vehicles for obtaining discounts from personal health/medical providers or other professional service providers.

### SUMMARY OF THE INVENTION

Transactional costs associated with providing professional services are reduced by enabling prospective clients/patients and professional service providers to competitively negotiate fees for proffered services through an interactive on-line professional services auction transaction system implemented over a publicly accessible communications network such as the Internet. A separate on-line auction transaction system, which shares database resources with the professional services auction transaction system, is also provided for implementing an arrangement for auctioning options to purchase services (i.e., a service option) at a discount (e.g., discount coupons or analogous vehicles that are applicable toward fees charged for proffered professional services). A person-to-person network marketing arrangement and method for rewarding existing member professional service providers for recruiting prospective new service provider members and training them in the use of the on-line auction transaction systems is also fostered and supported via the on-line professional services auction transaction system. Using the same arrangement, prospective users of the online auctions may be rewarded for usage training and recruitment of new users.

In an example arrangement, the present invention implements a professional services auction transaction system using a digital communications network server that interfaces and communicates via the Internet with client computer systems belonging to various prospective bidders and professional service providers (e.g., personal medical, financial or legal service providers) using, for example, an exchange of HTML documents and/or JAVA script applets. A transaction system server handles on-line communications and procedures for conducting public on-line auctions for the performance of proffered professional services and maintains one or more databases of information concerning registered service providers and bidders. An authentication/qualifier engine within the system automatically researches and verifies the credentials of prospective member service providers, as well as maintains background information on all registered service providers.

Databases containing member professional service provider credentials information and other information as well as one or more search engines for researching and/or verifying the qualifications of a particular professional service provider are provided and made available to a bidder on-line via web-page menu driven interface. An on-line user service feedback web-page and database are provided for acquiring and maintaining comments and feedback from both service providers and their patients/clients regarding the complexity and quality of services received or provided. The transaction system may also include remote client-server hardware/software facilities for providing customized database and computational services to auction bidders and professional service providers for communicating and participating in on-line bidding activities. An integrated life and health insurance product is also provided that permits trading equity in health insurance policy death benefits when bidding for health services used for the purpose of life prolongation. In the example embodiment discussed herein, the present invention is disclosed primarily in the context of providing the flexibility of an on-line auctioning process in negotiating a price for the performance of a professional personal medical service performed by a medical physician on an individual patient—in contrast to, for example, a remotely rendered impersonal professional opinion or service such as the reading of an X-ray or an MRI image. The present invention may also be used to provide the flexibility of an on-line auctioning process for soliciting discount coupons/certificates or developing a user marketing/training network and/or for marketing other professional services such as, for example, legal or financial services.

In the context of providing such professional services, it is desirable to provide a convenient mechanism for a prospective bidder to verify that a selected service provider is properly qualified to perform an offered service and for informing the bidder as to the likely quality of the service to be provided at a particular time, location and price. Another problem that arises primarily within the context of providing an on-line auction forum for professional medical services is that a medical service provider has no convenient way to assess the medical history or physical condition of a prospective patient. Since the extent and cost of treating a particular patient may depend upon the patient's medical history, it may be difficult for a provider to affix a specific offering price on a particular medical service or procedure. Consequently, one beneficial feature of the present invention is an on-line provision for allowing prospective medical service providers to assess the physical condition and medical history of a prospective patient. In addition, the present invention provides a fair and symmetric mechanism for accommodating errors made in the appropriateness of rendering a particular medical service or procedure without having full knowledge of a patient's pre-existing medical condition.

The present invention also introduces helpful transaction evaluation features such as an associated “complexity rating” for a particular service/procedure and a “complexity divergence” indicator which provides an indication of the degree that a particular service/procedure may ultimately differ (e.g., due to unforeseeable complications or severity of the treated condition) from the conventional known complexity associated with that service/procedure. Such features can serve to prevent various privacy issues that might arise during such transactions from encumbering the bidding process and can make the overall transaction more equitable. For example, the bidding process may be made contingent on the medical appropriateness of the service that was actually rendered and the amount ultimately to be paid on a winning bid may be varied based on a complexity rating for the procedure and the complexity divergence score attributed to a particular patient. In this manner, the moral, ethical and legal obligations of a medical practitioner/provider may be met and the mutual bidder/seller's interests fully protected.

In the context of obtaining personal medical services, for example, people who are uninsured or only partially covered by an insurance policy are provided a more convenient mechanism for identifying and contacting a high quality, qualified medical service provider that will provide a desired medical service at the desired quality, time, location and price. Medical service providers who own or operate medical facilities for performing such services are often willing to reduce fees if it would enable them to keep the staff and resources of their facility from being underutilized. For example, during slow or inactive periods, the under utilization of facility and staff reduces profitability and thereby drives up costs for conventionally scheduled patients.

This invention provides a mechanism whereby a patient, an agent acting on a patient's behalf or an insurance company can identify an underutilized facility thus enables the insurance company to negotiate a lower price for the policyholder. An uninsured patient may also secure the services at a more favorable price by agreeing to have the desired medical service performed during a period of what is otherwise expected to be facility underutilization. Such facilities and providers also may agree to lower pricing if they receive payment at time of bid closure instead of, for example, after a customary 8-12 week post-service insurance reimbursement delay.

Subject to certain restrictions, such as the availability of an otherwise underutilized medical facility in reasonable geographic proximity to the patient, a novel type of medical insurance policy may be offered wherein the policyholder agrees to have a desired medical procedure or service performed at an otherwise underutilized facility at “market value.” The cost for such a “market value” policy can be reduced because the insurer may be able to negotiate a lower price for securing a needed service on a case-by-case basis (e.g., by contracting to have a service performed at a particular time, or within a specified range of times, in an otherwise underutilized facility).

Alternatively, a novel lower-cost lifetime (or shorter period) maximum benefit insurance package could be offered in such a market (i.e., such that introduced by the present invention). For example, the premium rate for such an insurance policy could be set proportional or inversely proportional to the residual benefit in either a linear or a non-linear fashion.

Alternatively still, a novel insurance package could be provided in which health and death benefits are combined together. In accordance with one such contemplated example insurance package arrangement, the accrued death benefit of the policy (e.g., using the standard life insurance policy model) can be used to bid for health benefit services to preserve life. The expense (e.g., finalized bid price) of the rendered medical services is taken from the policy residual death benefit and the policy holder's death benefit then becomes the remaining balance. This creates a situation of finite resources that will impose market forces on health providers where each consumer strives to get the best quality for the best price and preserve the remaining benefit for themselves and their families. The individual again is empowered to make those critical heath care decisions and impose market forces on existing providers by means of this device and method.

Typically, facilities providing medical services, particularly elective procedures, spend a significant portion of their operating budget on advertising and promotion. An important purpose of the advertising is to assure that the facility is fully utilized. This invention provides other means for assuring efficient facility utilization. Thus, even if medical services were to be provided at a reduced price, the savings realized by reduced advertising and promotion now can be shared with the patient, thereby reducing overall medical costs for the consumer and increasing profitability for the medical service provider. This invention provides a method and apparatus that will enable prospective patients to easily identify and access an otherwise underutilized medical facility to negotiate a favorable fee for services subject to scheduling restrictions and other “specifications” set by the medical service provider. Likewise, underutilized medical facilities may now offer services at a negotiable fee in order to more fully utilize the resources of the facility.

Conventionally, most medical services are sold under a fixed-price protocol whereby the medical service provider sets a price for the service and a patient either accepts or rejects the price. The time, and sometimes the place, that the services are rendered in accordance with this protocol may be regarded as “flexible” in the sense that a medical service provider will typically establish a time and place (i.e., specifications) for rendering the service that is mutually acceptable to the parties. However, alternative protocols for perfecting buy-sell transactions between patients and medical service providers that are responsive to market forces, such as, for example, an auction or an exchange for buying or selling medical services similar to a stock exchange, have not been traditionally available.

Market research has indicated that people, lacking insurance for reimbursement of drug costs, typically pay as much as 15% more for a prescription medicine than people having such insurance for the same medicine. For example, seniors without drug coverage may not only lack insurance to protect against high costs, but may not have access to discounts and rebates that insured people receive. Uninsured persons may not purchase a needed prescription medicine simply because they cannot afford it. Moreover, market research indicates that spending for prescription drugs is currently growing at a rate that is twice that of other types of healthcare expenditures. This perceived inequity in pricing between insured and uninsured prescription medicine buyers now may be diminished by this invention providing a marketing system and method that enables the uninsured to buy prescription medicines at a “fair market price” that is both dynamic and determined as a result of competitive market forces. For example, overstocked medications that are to expire in 6 months may be sold at half price to those patients that can use them immediately.

This invention more efficiently schedules personal physician procedures during known predictable slow times (for instance during the night) so as to better match medical resources with medical needs across geographic/time domains. For example, this invention can provide an automated system where a doctor is enabled to accept certain bid/cost proposals for his/her services and then decide whether to accept or decline the bid price (thus more efficiently and economically distributing medical services to desiring patients that might pay a lower cost because the procedure would be done during “off” hours or the like).

The present invention may be implemented using a client computer system or suitable handheld wireless device comprising a telecommunications link to a remote medical transaction server via a digital communications network, such as the Internet, for enabling prospective buyers of medical services to negotiate with providers of medical services to identify and secure a reduced market-driven price for desired medical services. If desired, a condition may be imposed so that that the services will be rendered by the facility during a period of what would otherwise be facility underutilization.

The present invention may also be implemented using a medical transaction system comprising telecommunication links to a digital communications network, such as the Internet, that enables a plurality of prospective sellers of medical services to offer medical services to patients, insurers, and other third parties using an auction format. A minimum reserve price may be established for bids received using an auction format.

A buyer and seller of medical services can also communicate with each other to establish a mutually acceptable fee for services, the mutually acceptable fee being subject to a medical evaluation and restriction regarding the time and place where the medical services will be provided. Options may be provided in choosing a less convenient time and place for receiving medical services in exchange for a better price for his/her needed medical services. The qualifications of a medical service provider for the provision of an offered medical service may be authenticated. In fact a buyer and seller of medical services may have access to each other's respective transaction history and feedback history.

The present invention also provides a business method and system for providing an on-line auction of an option to purchase services (i.e., a service option). As an example embodiment, medical services and/or medical supplies (e.g., prescription medicines) may be offered for sale in an on-line auction forum subject to selected conditions that can be specified by a medical service provider such as, for example, the time and/or place where the personal medical service is to be rendered. In addition, as described in greater detail below, the present invention further provides a business method and system for providing an on-line auction of options to purchase services at a discount and/or analogous options. As an example embodiment, discount coupons to purchase proffered medical services at a discount may be placed up for auction on line by a medical service provider.

In addition, the invention may enable patients, whether insured or uninsured, to acquire elective surgical services, chronic rehabilitation services, medical equipment support, and other non-emergency medical and dental services through an auction format bidding process. Various covered and non-covered services such as podiatry, chiropractic, acupuncture, homeopathic, behavioral modification treatment and therapy, weight loss, hypnotherapy and other health related services may also be included for on-line listing and bidding in an auction format using the method and system of the present invention. Although many medically-related health services and products are subject to regulation to assure quality, the establishment of specific qualifying conditions and quality control measures may be implemented by the system of the present invention.

An efficient arrangement is also provided for on-line solicitation of consumer feedback information from patients which, after being acquired, is maintained in a transaction database and made accessible to other prospective patients. The convenience of on-line availability of a consumer feedback database to prospective patients and other buyers of medical services should ultimately serve to improve the quality of medical services provided to patients.

As another feature of the present invention, a person desiring a specific medical service is provided with a means to identify a medical facility offering such services and can negotiate obtaining the services at a “preferred” price in return for agreeing to receive the services during a period of otherwise expected facility underutilization. A yet further feature of the present invention allows a “standby” option to be implemented wherein the performance of services are provided at a reduced rate to a buyer willing to accept treatment on a “standby” or delayed basis. This is particularly beneficial in that it provides a further component of cost reduction to the patient and/or his/her insurer and could provide the medical provider with greater assurance that revenue is not lost. Using the bidding/auction-type format of the present invention, payment (either partial or full) may be made or secured electronically at the time a bid is accepted (rather than the customary 8-12 weeks after provision of a service, a basketful of paperwork and a plurality of phone calls).

A practical market-driven system that permits efficient buying and selling of medical services should also be subject to both strict quality control and acceptable practices by the medical community. Consequently, another aspect of the present invention is that a medical service provider's qualifications are preferably authenticated/verified using an authentication engine prior to posting either a global or local offer to sell a service. In addition, an offer-acceptance agreement between a medical service provider and a patient may also be optionally qualified by a restriction that a patient submit to a medical evaluation to establish the appropriateness of the medical service for the particular patient.

As still a further feature of the present invention, a qualified buyer of prescription medicine and non-prescription medicine is permitted to post a proposal to buy medicine at a particular price, for example, via a database accessible to qualified vendors, and may also receive offers for sale of the same medicine from one or more qualified venders at a proposed purchase price.

Direct links to one or more transaction feedback databases are also established to allow consumers of medical services to verify and evaluate a particular provider's product or service. The present invention also allows an agreement between a patient and a medical service provider to be conditioned on the establishment of medical fitness conditions of the prospective patient for receiving a particular medical service.

The on-line transaction system arrangement of the present invention further includes distinct auction transaction engine components for the purpose of supporting a separate on-line auction (i.e., separate from the professional medical services auction) for the auctioning of options to purchase proffered services at a discount (i.e., discount coupons) or analogous options for obtaining discounts that are redeemable against winning bid fees charged by a service provider for the proffered services. Using this aspect of the invention, a service provider has a choice of either providing a pricing profile listing proffered services with specific associated minimum bid prices on the services auction web-site or, if not willing to disclose a pricing profile or specific prices for proffered services, the provider may alternatively (or additionally) offer a discount coupon for specific proffered services on the associated discount coupon auction web-site. The present invention also combines the use of distinct auction transaction engine components with the sharing of common database elements for further facilitating the on line auctioning of such discount coupons (and/or analogous options to purchase services at a discount) in cooperation with a separate on line auctioning system for products/services.

As still a further feature of the present invention, the transaction system of the present invention further includes a method and arrangement for implementing on line a person-to-person network marketing business model for rewarding existing member professional service providers for the recruiting of prospective new service provider members and for training them in the use of the on-line auction transaction systems described herein. A user network of training and rewards can similarly be implemented. This aspect of the present invention promotes the creation and development of a network of service provider members (and to a lesser degree purchases of health services) for the recruitment and training of additional service providers.

In general, the present invention provides an efficient apparatus and method for exerting market forces on the cost of delivering professional services and for streamlining potentially costly administrative procedures associated with providing such services.

### BRIEF DESCRIPTION OF THE DRAWINGS

These and other features and advantages provided by the invention will be better and more completely understood by referring to the following detailed description of presently preferred embodiments in conjunction with the drawings, of which:

FIG. 1 is a block diagram illustrating an example client-server arrangement for an on-line marketing/auction transaction system and an example service provider computer system arrangement;

FIG. 2 is a bar graph illustrating an example of a service provider's facility utilization projection for a particular time period;

FIG. 3 is a chart illustrating an example forecast of a service provider's projected facility revenues for a particular time period;

FIG. 4 is a table that illustrates an example data structure arrangement for a procedure pricing database that may be used by a medical service provider/facility;

FIG. 5 is a table that illustrates an example proffered service facility schedule for identifying periods of facility underutilization;

FIG. 6 is a block diagram illustrating an example service provider computer system arrangement for computing an offering price and interfacing to the on-line marketing/auction transaction system of the present invention;

FIG. 7 is a block diagram illustrating an example on-line marketing/auction transaction system for professional service providers and customers/bidders of proffered services;

FIG. 8 is a block diagram illustrating the organization of an example user interface browser web page for the medical auction transaction system example of the present invention;

FIG. 9 is a block diagram illustrating the interactive relationship between various functional aspects of the example medical auction transaction system of the present invention;

FIG. 10 is a block diagram illustrating example linking web pages accessible on line via a web-site main page of the medical transaction system of the present invention;

FIG. 11 is a block diagram illustrating example functional processes available to a web-site on-line visitor upon accessing the medical transaction system of the present invention;

FIG. 12 is a bitmapped image screenshot of an example proffered services menu web page provided on line to a prospective bidder;

FIG. 13 is a bitmapped image screenshot of an example user log-in web page provided on line for registered users of the transaction system of the present invention;

FIG. 14 is a bitmapped image screenshot of an example registration form web page provided on line to prospective uses of the transaction system of the present invention;

FIGS. 15A-15D are a bitmapped image screenshots of an example “Place-ad” form web page provided on line to a service provider;

FIG. 16 is a bitmapped image screenshot of an example user “Search-item” web page provided on line to a prospective bidder;

FIGS. 17A and 17B is a bitmapped image screenshot of an example bidding form web page provided on line to a registered bidder;

FIG. 18 is a bitmapped image screenshot of an example Bidder Feedback form web page provided to an on-line registered bidder;

FIG. 19 is a bitmapped image screenshot of an example Provider's Feedback Form web page provided to an on-line registered service provider; and

FIG. 20 is a block diagram illustrating example information flow and functional processes for implementing a separate discount coupon auction web page that shares database resources with the medical transaction system of the present invention.

### DETAILED DESCRIPTION OF EXEMPLARY EMBODIMENTS OF THE INVENTION

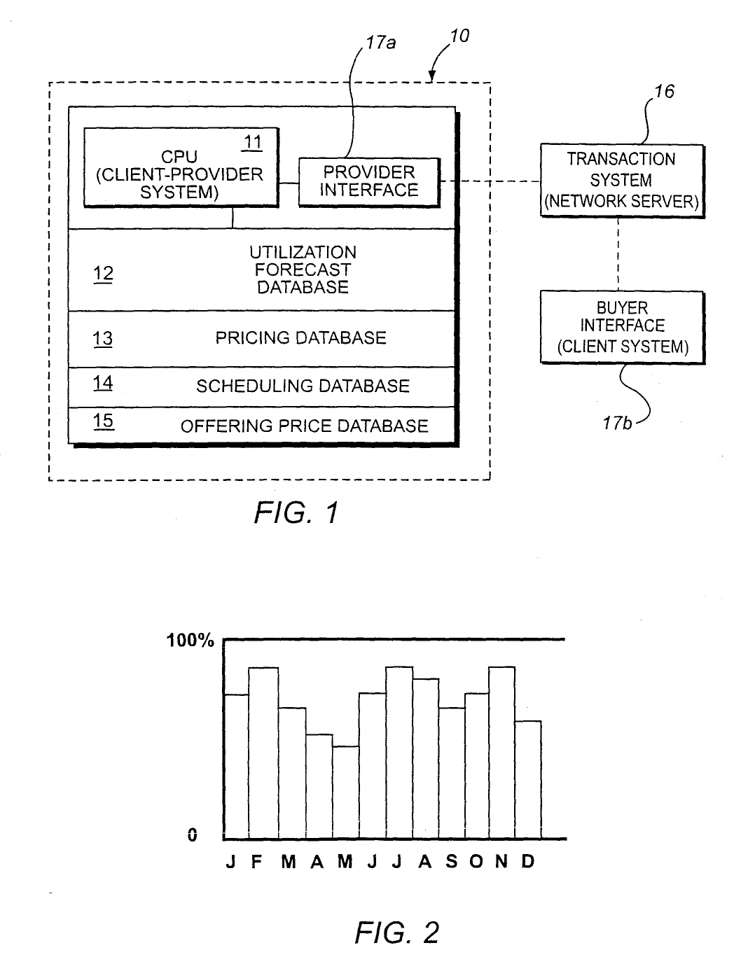

FIG. 1 illustrates an example client-server arrangement for an on-line marketing/auction transaction system and an example service provider computer system arrangement. an exemplary computer system (10) for use, for example, by a medical service provider enables a service provider to schedule facility utilization and to automatically compute an offering price which may be made dependent upon factors such as the temporal availability of facility resources and personnel.

The service provider's on-line client-server computer system 10 includes at least one central processing unit (CPU) 11 and a plurality of data bases 12 through 15 which may be maintained on one or more data storage devices. In this example, CPU 11 is connected to a facility utilization forecast database 12, a medical service standard pricing database 13 and a facility-maintained facility scheduling database 14. CPU 11 utilizes information stored in facility utilization forecast database 12 and pricing database 13 to compute a special offering price for services rendered during periods of facility underutilization. The computed special offering price is stored in an offering price database 15. At a predetermined time, CPU 11 transfers (i.e., posts or uploads) data from the special offering price database 15 to a web-page server computer transaction system 16, for example, by means of a digital communications interface device 17a, such as a modem and associated telecommunication circuits. A prospective patient/buyer of medical services may likewise be connected to web-page server computer transaction system 16 via similar digital communications interface and commuter system 17b. For the purpose of the present description, information transferred from the provider may be collectively referred to as “specifications” for the proffered service. Such transferred specifications data may comprise, for example, scheduling information, a medical or professional service being offered for sale and a minimum bid starting price for the proffered service.

Specifications associated with a particular offered medical service may, for example, be determined by historical analysis of market behavior. FIG. 2 shows an exemplary graphical representation of projected utilization of a particular medical service facility based on historical use data. The percent utilization of facility resources is indicated along the ordinate for calendar month dates along the abscissa. In the example, certain months are seen to be more underutilized than others. Of course, the goal of an efficient medical service facility is 100% utilization of their resources during the entire year. Accordingly, it is to the medical service provider's advantage to schedule facility utilization, even at a reduced price, during the expected “low” utilization periods in order to at least partially offset operating costs of the facility. An increased number of patients/buyers of medical services may be attracted toward using the facility if the facility is willing to offer services at a special offering price during these otherwise expected low periods. The offering price for services that are scheduled for periods of greatest expected underutilization can be substantially reduced below a “standard” price in order to generate revenue to offset operating costs.

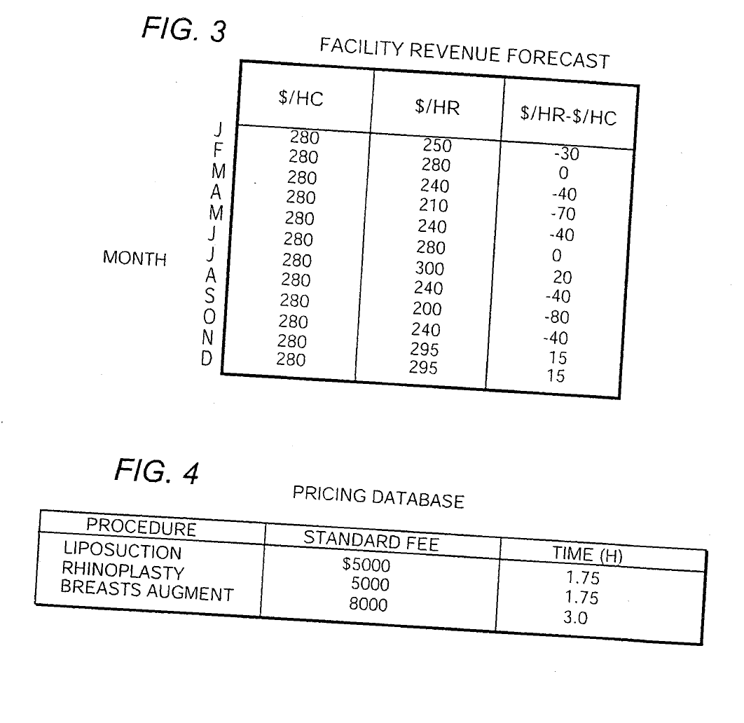

The historic average hourly revenue of a medical service facility, again using fictitious exemplary data, may be contained in a facility revenue forecast database such as that shown in FIG. 3. In this database, projected average hourly costs ($/HC) for operating the facility and projected average hourly facility revenue ($/HR) for each of the future months are stored. Projected net hourly income ($/HR−$/HC) for operation in future months is shown in column 3. In this example, eight of the twelve upcoming months indicate a loss in projected net hourly income. If the facility usage is increased during these “low” months, the net hourly revenue can be increased. The stored historic revenue data for the low months can be used to compute a special offering price for services to be rendered during the low months as will be discussed later.

Many medical service providers have a base pricing structure (e.g. a standardized base price or “BP”) for a particular medical service which is, for example, related to the difficulty, attendant risk and time required for rendering the service. Also associated with various medical services may be certain overhead expenses, fixed costs, risk reduction costs, and disposable costs. An example of such a base pricing structure for a plastic surgery “surgicenter” is illustrated by the pricing table of in FIG. 4.

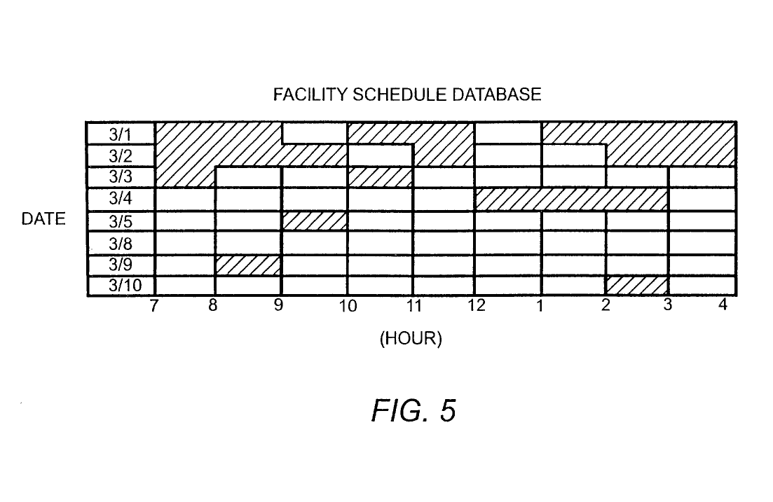

If a patient agrees to have one of the listed procedures performed at a time corresponding to a period of “low” utilization, the provider can offer a price reduction in consideration for the patient's flexibility in scheduling. As the facility schedule fills, the offering price of further offered services can be automatically adjusted upwardly in response to the degree of then-anticipated future underutilization. That is, data reflecting the scheduled utilization of the facility, as maintained in a facility schedule database illustrated by the chart at FIG. 5, can be constantly updated as patients purchase services at special offering prices. When the scheduled utilization exceeds the projected utilization for a particular time period, the special offering price can be selectively increased or decreased, in a manner that is sensitive and responsive to the demand for services.

A medical service provider may employ a customized algorithm, encoded and stored, for example, on a computer-readable medium, to compute a preferred offering price (“OP”) for a particular medical procedure in a format that can be up-loaded on-line onto the interactive transaction system 16 for posting and solicitation of registered buyers. For example, consider a board certified (i.e. qualified) plastic and reconstructive surgeon who is a registered medical service provider having an upcoming surgery schedule as illustrated by the hatched areas of the chart in FIG. 5. The surgeon wishes to schedule one of a plurality of medical services that he/she is qualified to provide during the currently unscheduled time. The surgeon has a base price, BP=$10,000, which is charged for performing a face lift which takes, on average, four hours. On the schedule shown in FIG. 5, the only possible dates available for performing the 4 hour procedure (without rescheduling other procedures) are 3/3, 3/4, 3/5, 3/8, 3/9 and 3/10. There are 54 hours available for scheduling during these dates (i.e. T=54 hours) of which 8 hours have been scheduled. The unscheduled time (“UT”) available during these dates is 46 hours (i.e. UT=46 hours). An offering price (“OP”) may be computed using a formula given by Equation 1 below:

OP=BP+UT/T(RP−BP) Equation (1)

where “RP” is a reserve price for the procedure. That is to say that RP represents the minimum price that the surgeon is willing to accept for providing the face lift. The RP may, for example, be equal to or greater than the sum of the-out of pocket costs, including the price of implants (if necessary), disposables, malpractice insurance and facility costs such as payroll and equipment leasing. Of course, Equation (1) is only one of many possible algorithms that may be used for computing an OP.

In the above example, using Equation (1), the preferred OP for the procedure is:

OP=$10,000+46/54($5000−$10000)=$5741 Equation (2)

Thus, the surgeon may access transaction system 16 and post an offer to sell a face lift for $5741, with specifications (i.e. conditions precedent) attached thereto as follows:

Medical service ID: (system CPT code for face lift/Rhyditectomy)

Facility: Cedars of Sinai Outpatient Surgical Center

Location: Los Angeles, Calif.

Offering Price: $5741

Available Dates: 3/3-3/5/00 and 3/8-3/10/00

Payment: in full within 7 days of bid closure

Other requirements: lab work and medical evaluation prior to scheduled data of surgery

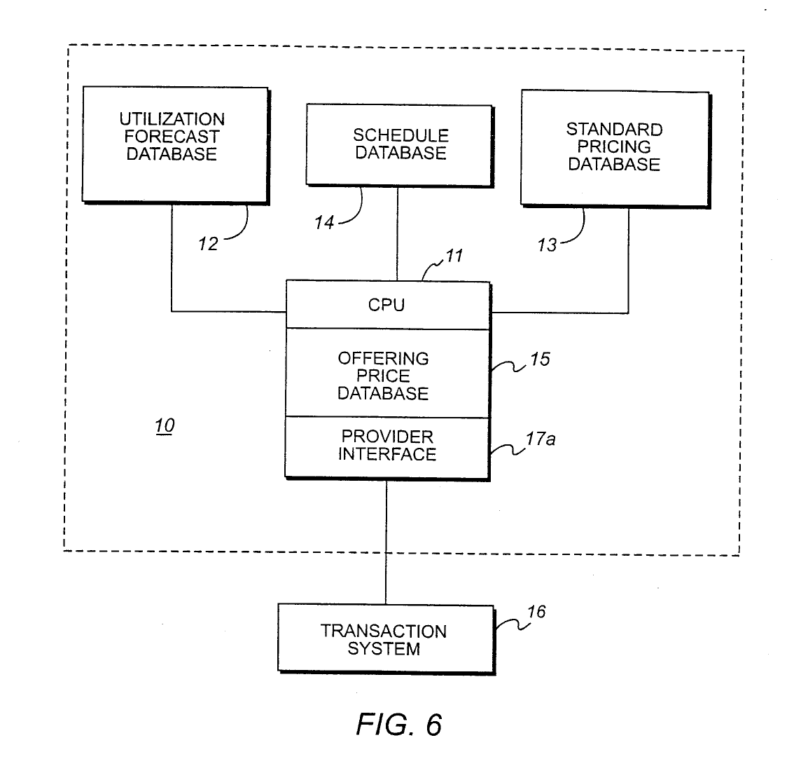

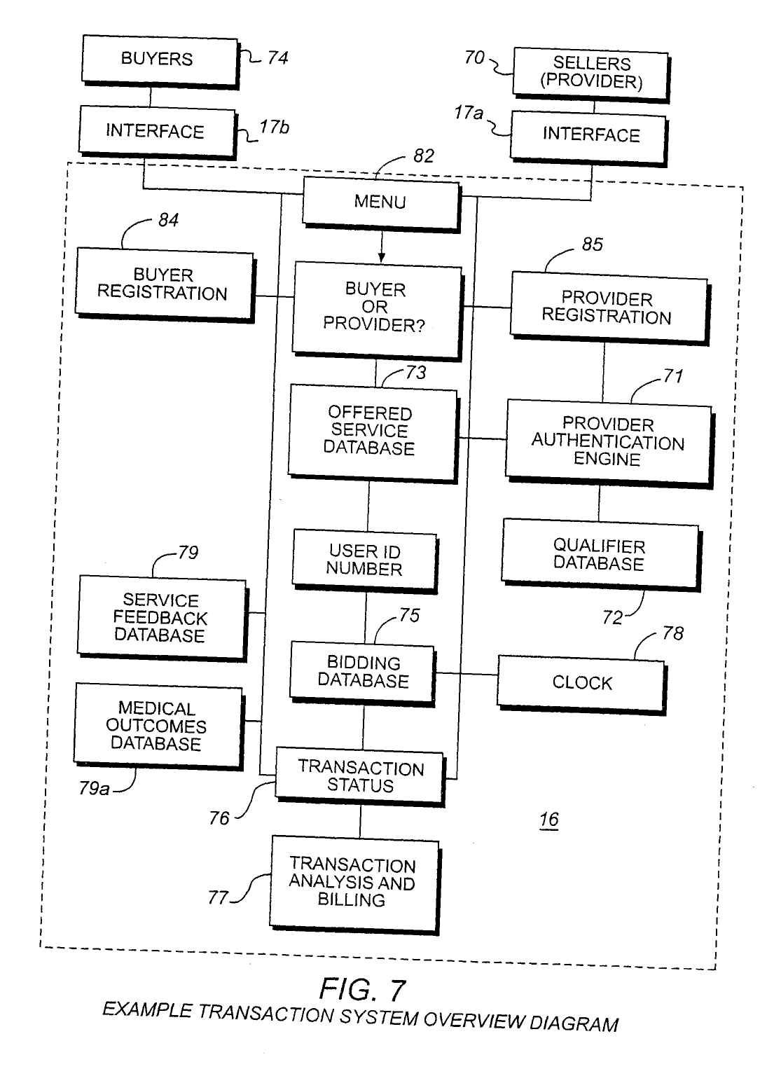

FIG. 6 is a block diagram illustrating an example scheduling and pricing system for a professional service provider and the connection arrangement between the service provider and an on-line interactive marketing/auction transaction system 16 of the present invention. For example, a professional service provider may implement an in-house scheduling and pricing system 10 comprising a CPU 11 and at least one large storage devices for maintaining one or more databases. The service provider uses system 10 to identify periods of projected future underutilization of its medical service facilities and then may offer its medical services to prospective patients during such otherwise underutilized periods at a reduced price such that the reduction in price is related to the projected under-utilization of the facility during the subject period. Historical facility utilization data contained in utilization forecast database 12 is compared by CPU 11 with scheduling information maintained in scheduling database 14—which contains, for example, information concerning scheduled services for the subject time period and the percent of currently expected facility utilization computed for each upcoming date. A standard pricing database 13, accessible by CPU 11, contains information concerning standard services and/or procedures including the usual time required for rendering each service and a base price for each service or procedure. The information maintained in the utilization forecast, schedule and standard pricing databases 12, 13, 14 is utilized by CPU 11 to compute a current offering price which is stored in offering price database 15. For example, offering price database 15 contains a list of upcoming dates, a list of procedures and/or services and a special offering price for services rendered at the specified date. In determining an offering price, CPU 11 computes an adjustment to the base price of a proffered service based upon the percentage of facility utilization which reduces the offering price when the percent utilization of the facility is low and raises the offering price as the percent of facility utilization increases. The foregoing description of an example service provider's scheduling and pricing system 10 for generating an offering price for services rendered during periods of low facility utilization, is not meant to be defining of all such systems but merely exemplary of one such system that may be used by a service provider for structuring a preferred offering price. This offering price is ultimately intended for posting, for example, on an on-line marketing/auction transaction system 16 such as a web-page server computer transaction system.

FIG. 7 is a block diagram illustrating an exemplary web-page server computer transaction system that is operable on line for conducting buy-sell and/or auction transactions between a medical service provider/facility offering medical services for sale, and patients desiring to buy such medical services. Although a single example transaction is disclosed wherein a medical service provider offers a specified medical service for sale at a preferred price and the offer is presented to a plurality of buyers for acceptance by a single buyer, a practitioner of ordinary skill in the art will realize that web-page server computer transaction system 16 may be used to implement many different types of marketing and auction transactions.

Referring now to FIG. 7, a specified medical service and associated price contained in an offering price database of a service provider's scheduling and pricing system 10 (FIG. 1), is transmitted to web-page server computer transaction system 16 via service provider-controlled interface 17a (which may comprise, for example, a keyboard/CPU/modem/telecom circuit or other conventional computer networking devices). Prior to posting the offer for sale, transaction system 16 prompts the provider (seller) 70 to enter a registration identifier. If the provider is not registered to offer services for sale on the system, the provider must register on-line. In order to register, the provider must identify himself/herself and enter one or more medical services that the provider is qualified to render. The provider's qualifications for performing the stated medical services are authenticated by means of a search engine 71 having a direct link to a qualifier database 72 and/or hyperlinks to one or more other qualifier databases 72.

Generally, as used herein, the term “search engine” means an apparatus (or method) automatically operable for receiving a user generated label, searching a directory comprised of one or more databases for a matching label and identifying databases within the directory which contain a matching label. The term “qualifier database,” as used herein, means an electronically accessible computer-readable storage medium containing authentic certification data for medical service providers. Some examples of qualifier databases include the AMA's membership roster, a State Medical Licensing Board's roster of licensed physicians, the American College of Surgeons roster of board certified surgeons and a roster of Board Certified Plastic and Reconstructive Surgeons, as well as specific hospital staff privileges roster. If the medical service provider is qualified to render the medical service being offered, the qualifications are authenticated by the system 16 and the provider-transmitted service and offering price data, including any restrictions (specifications) are accepted by the system 16 as a conditional offer for sale. Put another way, a statement of an intention to offer specified medical services for sale at a specified date and time, or range of dates and times, at a specified price is posted on an offered service database 73.

A plurality of patients 74 gain viewing access to the posted data via a patient interface 17a (e.g. via the Internet). If the conditional offer for sale is acceptable to a patient (or other buyer such as a patient's insurance company) who is a registered user of the system 16, the patient/buyer submits his/her offer to buy (bid) by on-line posting on a bidding database 75. If the offering price of the medical services, which offering price is included in the specifications of the offer to sell the medical service, is “fixed”, that is, not open to negotiation, the bid is compared with the offering price and, if a match occurs the bid is accepted and the transaction recorded in a transaction status storage device 76. If the consumer demand for the service at the posted “fixed” price is greater than the number of services offered at the “fixed” price, other bidders can bid the price higher to gain priority for the limited service at the “fixed” price (Dutch Auction).

Web-page server computer transaction system 16 notifies the buyer and seller that the transaction is complete and the registered buyer and seller identification and transaction selling price entered into a transaction analysis and billing database 77 wherein the parties to the transaction are billed for system use. The buyer and seller may then communicate directly in order to satisfy specifications posted by the provider such as scheduling a medical exam and arranging to have required lab work done prior to the time the medical service is to be rendered.

In the exemplary transaction presented above, the provider's offer to sell the medical service cannot be construed as an actual offer for sale because the facility's ability to render consideration is limited by the facility's scheduling capacity. In other words, thousands of patients viewing an offer to perform a rhinoplasty on Thursday, May 22, 2001, at 7:45 AM at a special price of $2500, cannot all be rendered consideration by the offering facility. Thus, the system 16 must be able to receive offers to buy a posted medical service in a serial manner to enable the medical service facility to accept only those offers for which it can reasonably expect to provide consideration, and reject buy offers received after 100% facility utilization is realized. Accordingly, a clock 78 records the time that an offer to buy is placed to prioritize such bids. Higher bids (i.e. bid purchase prices exceeding the “fixed” price) may receive priority over a lower, but otherwise acceptable, bid which is received earlier. After the medical service provider's facility schedule is full for specified dates and times, additional patients' buy offers (bids) are either rejected or may be accepted by the medical service provider on a “standby” basis for other future slots.

In any practical buy-sell system, whether market-driven or otherwise, the medical service provider must have the ability to bind a patient to a legal contract under the terms of the patient's offer to purchase. Similarly, the patient must have the ability to legally bind a medical service provider to the terms of the medical service provider's offer to sell. The system 16 may provide a registered prospective purchaser of medical services access to quality assurance data relating to the qualifications of the provider that are required in order to provide the particular medical service, such as, for example, statutory state and federal provider requirements, provider qualifications, hospital privileges and board certifications.

In the future, the data that is made available to prospective buyers of medical services may be enlarged to provide transaction outcomes history and other performance criteria about the provider as the data becomes available to the public via the system 16 or other Internet links. The availability of such additional transaction outcome historical data for a provider will allow the consumer of medical services to bid with confidence; being reasonably assured by the experience of others that he/she will be getting the “best quality for best price”. In this respect the system provides the consumer with information that has not previously been readily accessible and/or verifiable. Most medical referrals are currently made by roster participation (lowest bidder). Provider selection is also typically made from neighborhood hearsay data, combined with such a list of qualified providers.

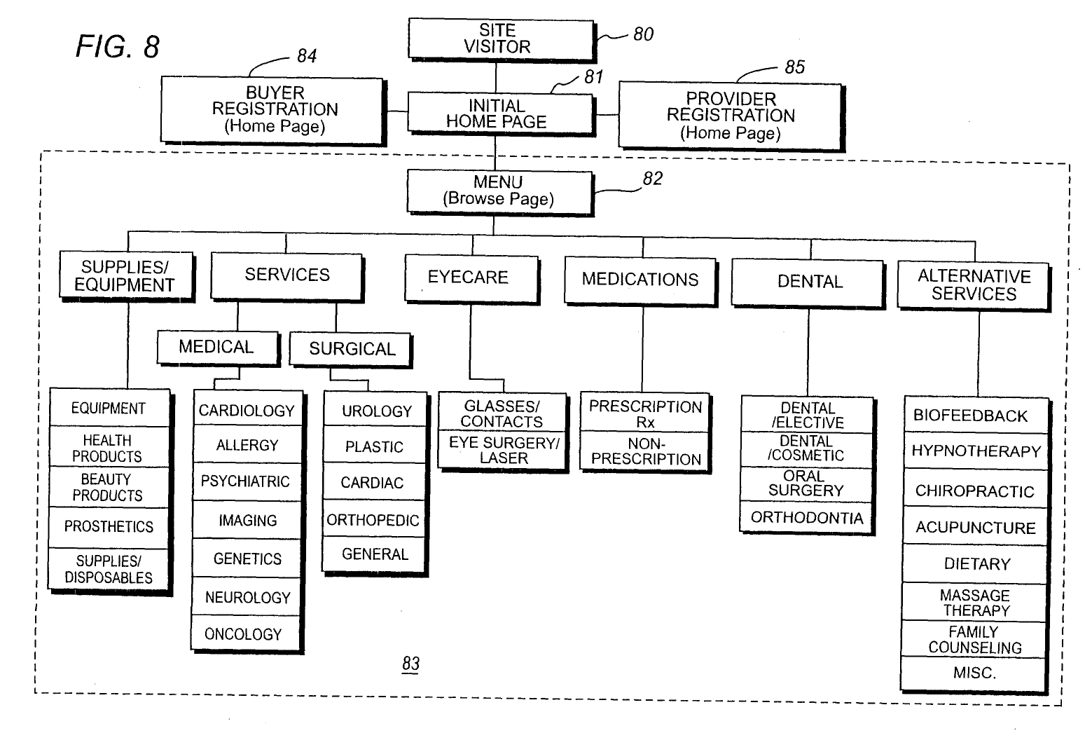

An example of a “home page” having an Internet identifier: “emedicalbid.com”, useful for accessing and browsing the system 16 in accordance with the present invention, is depicted schematically in FIG. 8. A visitor 80, who may be either a prospective buyer or seller, is directed to the home page screen 81 and identifies himself/herself/themselves as either a buyer, a seller, or payor, (e.g. an insurer) of medical services/products, and provided with a menu 82 displaying a variety of medical related services and product options, including options for buying or selling medical services, medical equipment, and medical supplies such as drugs. The visitor 80 may browse the various menu-linked service databases 83 by choosing the desired category of services. If the visitor wishes to buy or sell a medical service, the visitor must first complete a registration process by completing a buyer registration questionnaire 84 or a provider registration questionnaire 85. The buyer of services may be similarly subjected to credit qualification to minimize “no show bids”.

The term “medical services”, as used herein, includes surgery, medicine, radiology, medical equipment sales or leasing, pharmacy, alternative medical services, dentistry and dental procedures, rehabilitation services and other medical services, the provision of which are subject to licensing. The method for selling a medical service in accordance with the present invention requires enrolling at least one, and preferably a plurality of, medical service provider(s) using an on-line registration system. After a medical service provider is enrolled, the medical service provider may request the system 16 to post an offer to sell a specified medical service included within the menu 82 of medical services at a specified offering price.

Web-page server computer transaction system 16 authenticates the qualifications of the medical service provider by searching the qualifier database 72 (FIG. 7). The qualifier database 72 includes every service listed in the menu of medical services and the licensing requirements for providing the particular service. The qualifier database contains a list of medical services, the qualifying requirements for rendering such medical services, and hyperlinks to databases storing the identification of medical service providers having satisfied a particular qualifying requirement. If the provider's qualifications for performing a particular service have not been previously authenticated by the system, a software qualification engine will access and search external databases that identify qualified providers for the particular medical service.

In an example embodiment of the qualification engine of the present invention, a medical specialty Board Certification awarded to a given practitioner is used to define the cluster of CPT coded procedures that the practitioner may perform well. If a practitioner posts a procedure or service for bids for which he/she is not duly certified, an internal alert is raised by the qualification engine and a request for specific qualifications is made to practitioner. In this manner, the qualification engine prevents a cardiologist, for example, from posting a body liposuction as a procedure for soliciting bids. Moreover, the qualification engine may implement this and other predetermined restrictions using an evolving list of threshold qualifiers for accommodating orphan procedures practiced by the various medical specialties.

Once the qualifications are authenticated, an offer to sell the specified medical service and the specified offering price is posted on a global database 73 that is accessible, on-line, to a plurality of buyers. For posting purposes, the system uses a basic qualification threshold. It may be desirable to provide means for the patient to access additional provider qualification to bolster the bidder's comfort with placing a bid. The system will prevent a dentist from posting an offer to perform a liposuction procedure but will not prevent a general surgeon (legally qualified) from offering such services. A provider's membership in the American Liposuction Society will be reassuring to the prospective bidder but such membership will not define the gateway to performing such a procedure.

It is the purpose of the system to bring free market forces to healthcare while providing a quality assurance umbrella. It is not the purpose to foster interdisciplinary territorial squabbles or facilitate medical market niches for any one medical subspecialty over another. Ultimately, provider competence and patient satisfaction (monitored by feedback database and medical outcomes database on each member) will be more influential with prospective buyers than certificates from obscure subspecialty entities. A prudent balance between qualifier threshold and the fostering of competitive markets are possible with the system 16 in accordance with the present invention.

The system 16 provides free system access to a plurality of prospective buyers for the purpose of viewing offered medical services. In order for a prospective buyer to purchase a listed service at a listed purchase price, or at any price, the prospective buyer of medical services must first enroll using an on-line registration system 84. Once enrolled (registered), a buyer is issued a buyer identifier and, using the identifier, may place an offer to purchase the listed medical service. The system receives the offer to buy, accompanied by a specified purchase price, from the buyer, and if the specified purchase price in the offer to buy the specified medical service is greater than or equal to the last bid price, the offer is accepted and stored in a transaction status database 76. The transaction status database 76 includes a processor that provides an output to the seller identifying the buyer and enabling direct communication therebetween. The parties to the closed transaction are then billed for system use via the transaction analysis and billing processing unit 77.

The method for buying and selling a medical service, described above, is efficient and has advantages realized by both the buyer and the seller. The seller can reduce advertising costs and use facility resources more efficiently. The buyer secures needed or desired medical services by accepting restrictions regarding when and where the service is provided as set forth in the specifications accompanying an offered medical service. The method may not in all instances, however, fully bring market forces to bear on the pricing of medical services. In the above example, the price is set by the medical service provider either at a “fixed” price or at the highest price proffered in a Dutch auction, and is either accepted or rejected by the buyer. The power of the present invention is better realized by opening the price of medical services to competitive bidding, most preferably in the form of an auction.

The above-described method for selling and acquiring medical services at a fixed price can be modified to meet objectives of the present invention by posting offers to sell medical services on a global database at an open, unspecified price that exceeds a fixed minimum reserve price. In accordance with the preferred method of the present invention, the enrollment and authentication of buyers and sellers is implemented as described above. The medical service provider (seller) submits an offer to sell specified medical services at a price to exceed a minimum reserve price. After the system 16 receives the offer and authenticates the medical service provider's qualifications to provide the medical service in the manner described above, the offer to sell is posted on a globally accessible offered service database 73.

A plurality of registered buyers 74, viewing the offer to sell, may submit an offer to buy the offered medical service. The purchase offer and the time that the offer is received by the system are stored. The proffered purchase price, specified in the offer to purchase, is compared with the reserve price specified by the seller. If the proffered purchase price is equal to or greater than the reserve price, the purchase offer is entered into the bidding database and the time that the offer was proffered is recorded. A second prospective buyer may view the first buyer's proffered offer and submit a second offer to purchase the medical service at a price that exceeds the price offered by the first prospective buyer. If the purchase offer proffered by the second buyer is greater than the price proffered by the first buyer, the offer proffered by the second buyer is entered and the first buyer notified that a higher bid was received. The first buyer, or any other buyer viewing the second buyer's offer, can proffer a third offer that exceeds the then-current highest offer. The process continues until the time allocated for closing the transaction, specified by the seller, has been reached, and further bidding is closed. As in the seller-fixed-price example of the method described earlier, the parties to the transaction are noticed that the transaction is complete and then they are billed at 77.

The provider feedback database 79 of the system 16, illustrated in FIG. 7, provides means for the buyer to comment on the transaction after the medical services are rendered, the comments providing feedback regarding provider performance which is stored in the database 79 for future reference. Transaction feedback may be stored separately from a medical outcomes database 79a which may take longer to acquire and derive meaningful data.

The method of the present invention also contemplates purchasing of medical services at a price determined by buyers. In this example of the method, a registered buyer 74 logs onto the system 16, selects a medical service that the buyer wishes to acquire and proffers a purchase price for the medical service. If the buyer is registered, the purchase offer is posted on a “services wanted” bidding database 75, which is accessible to a plurality of registered providers of medical services. If a provider viewing the offer to buy wishes to provide the medical service at the proffered seller-set price, the medical service provider submits an offer to sell the specified services to the system. After the medical service provider's qualifications for providing the medical service are authenticated by the system, the offer to sell is posted for viewing by the buyer. The buyer may either accept the offer to sell, and all conditions specified in the offer to sell, such as the location and date that the services will be rendered, or defer acceptance of a particular offer until a specified time. Further offers to sell medical services to the buyer may be submitted by qualified sellers until the time window specified by the buyer for receiving offers closes. The buyer may accept or reject any medical service provider's offer to sell without cause.

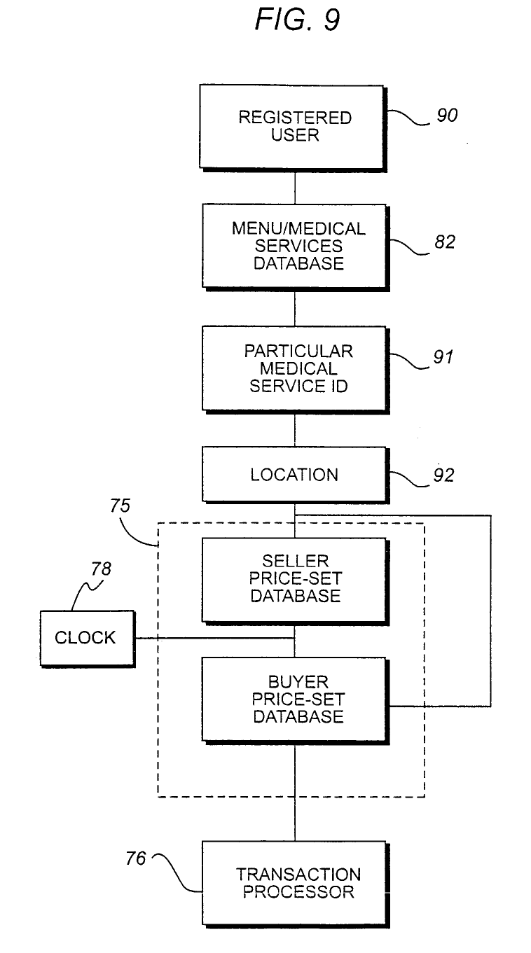

Any buyer, once registered, whether a patient, an agent of the patient or an insurer, may use the system and method of the present invention to bid for an offered medical service. The registered buyer may also use the system 16 to post an offer to purchase a specified medical service and solicit bids for the specified medical service from medical service providers. With reference now to FIG. 9, to use the system 16, the registered user 90 is linked to a menu 82 of medical services (shown in more detail at 83 in FIG. 8). The registered user 90 selects a particular medical service 91 from the menu 82 and is prompted to identify a location at 92, by city and state, where the particular medical service is to be rendered. The registered user is then provided with a choice of ways for offering to buy or sell the particular medical service 91. For example, a buyer may scan the offers to sell the particular medical service in the geographical area of interest that are posted on the bidding database. The buyer can either purchase the medical service at the price specified by the medical service provider or proffer a purchase price that is less than the specified selling price. The buyer's bid is compared with the highest previous bid received from other buyers which is stored in the bidding database, and either replaces the highest bid in the bidding database or is rejected. The bidder may be noticed of the previous highest bid prior to entering a bid thereby providing the opportunity to increase the bid.

If the medical service provider has specified a minimum reserve selling price which is greater than the proffered offering price, the proffered offer to purchase can, at the buyer's option, be posted in a buyer-priced database, and the offer to purchase made available for viewing by a plurality of registered medical service providers. A medical service provider viewing the offer to purchase may proffer an offer to sell the posted particular medical service, which offer is stored in the buyer-priced database. The prospective buyer is noticed of the proffer and may either accept or reject the proffer, along with the specifications connected to the proffer.

The formation of a legally binding contract between parties requires (a) mutual consent to the same terms and conditions; and (b) consideration. If the buy-sell transaction is conducted, in part, by electronic telecommunication, a practical system must additionally comply with the legal requirements for perfecting an agreement under electronic contracting law; an area of law that is evolving. Any agreement between a medical service provider and a patient and/or a patient's insurance company must provide for termination of the agreement in the event that either the medical risk for the patient has changed after the agreement was entered into and before services are to be rendered, or the medical service provider is unable to render the medical service at the time the service is to be performed for a cause reasonably beyond the control of the provider. These considerations, as well as means for dealing with them, are contemplated in the present invention.

The system presented herein provides flexibility for both the medical service provider and the buyer (or payor). For example, a provider may offer a package that includes surgery, a hospital bed (for x days), hospital services, anesthesia and operating room. Alternatively, the provider may offer the package and include the hospital bed for only one day after which the cost of the bed is extra. The buyer can search for a provider that is offering a hospital bed and services at a better price, and arrange to be transferred to the other hospital bed after the first day included within the contracted package has passed.

A low hospital bed occupation census is economically wasteful because the hospital must maintain full time staffing in a “ready mode”, prepared to take care of various medical and surgical events during all shifts. The cost of maintaining such highly skilled labor and services is high, both in terms of monthly payroll and the cost of compliance with imposed regulatory procedures that a hospital must deal with. As an example, consider a well-staffed hospital experiencing a low patient census situation during the month of February. Such a low census could be a seasonally cyclical effect, or due to a slump in the local economy. A major managed care provider may have taken all its subscribers to a competing cross-town hospital that offered them a better per diem contract. Whatever the reason for the low patient census, the hospital must respond effectively or close its doors.

The hospital may respond to the low census event by posting an offer on the medical auction transaction system web site to sell per diem single bed medical care services for ten patients, which include per diem (base rate) operating costs for one patient along with the associated nominal medical and nursing services, at a reserve price of $800.00 per patient per day. (The hospital's normal per diem base rate charge being, for example, $1800 per day. Although the hospital might normally expect to receive a per diem fee of around $1560 from Medicare, it may actually receive only $1260 per diem, for example, from another managed-care plan—which would only be marginal for meeting operating costs. Consequently, if a patient is admitted and needs costly care, the hospital loses money at that rate. Nevertheless, the hospital benefits the community by taking care of needy and uninsured patients and participates with dominant community insurance plans, even if they reimburse only marginally.) An insurance carrier with a large population of subscribers may see the hospital's offer to sell and choose to place a bid for the per diem beds with the intent to place its community subscribers in the offering hospital when such hospital services are needed. The insurance carrier may chose to purchase all ten beds by bidding on-line, hoping to benefit from the sharply discounted per diem price. If the insurance carrier can utilize those beds, it will realize a profit. Ultimately, this should benefit the insurance consumer through a lowering of insurance premiums. The offered beds may also be bid upon by uninsured patients (an estimated 44 million exist) that seek an elective procedure and wish to reduce their out-of-pocket expenses.

Alternately, the same day-beds may be purchased or bid upon, for example, by a cardiac surgeon who needs to purchases cardiac/surgical per diems for prospective patients. Likewise, through use of the online auction transaction system, operating room use and ICU beds may also be auctioned by a hospital and acquired by a physician/surgeon. A surgeon, having purchased the beds through winning bids, may subsequently post an offer to provide (i.e., sell), for example, a competitive combined package for a coronary bypass graft procedure with the associated hospital beds for a four day stay. For example, he may decide to offer such a package at preferred price of $18,000 which would cover not only his services but also the per diem hospital services—which he purposely acquired via online auction at a significant discount to make the total package price more attractive.

The forgoing transaction works out well financially for the hospital, the physician, and the cardiopulmonary staff. By utilizing using an otherwise underutilized hospital and staff, the consumer/patient who undergoes the elective coronary bypass graft also ends up benefiting with a significant discount. In addition, by using the professional services online auction transaction of the present invention, the consumer/patient has an enhanced ability to evaluate the quality of the physician and the hospital through the associated qualifier database and patient feedback links. The qualifier engine and associated databases allow the qualifications of both the physician providing the service and the qualifications of the hospital/treatment facilities available to the consumer/patient.

In another example, bidders for specified hospital beds may include patients who have a large co-pay or deductible and who are under pressure to use cost effective services as well as patients that choose novel healthcare insurance policies that will evolve when consumer driven price/quality medical services, in accordance with the present invention, become available. Such novel insurance policies may include policies having limited lifetime benefits. A low cost insurance policy may be developed that offers a $100,000 lifetime benefit (similar to term life insurance) wherein the monthly premium increases in proportion to the diminishing residual lifetime benefit. The patient may purchase additional coverage in units of $100,000. Premium costs for such novel policies will be a function of age, risk factors, medical evaluation and residual coverage available under other policies. Such insurance policies will shift cost controls to patients (or their agents) and hereby facilitate the imposition of cost with quality controls on the healthcare providers.

The system and method described herein empowers the patient to impose cost constraints and quality assurance on each healthcare transaction. Thus, the patient is better positioned to press for improved quality and reduced price from the health care industry. Current managed care programs employ uninvolved managers to impose cost controls with the guise of quality on the healthcare provider and disempower the patient in the process. The system and method disclosed herein does what current systems fail to do: empower the patient to make cost and quality decisions about their own healthcare. Thirty years ago, healthcare providers strove for quality and gave minimal attention to cost controls. Today, healthcare providers strive for cost controls and give token attention to quality. Future healthcare delivery systems will need to embrace both quality and cost controls and empower the patient to choose the right balance between these two, historically polar, interactive forces.

As a further example of the flexibility the system offers, a patient requiring a medical service or procedure may select a hospital of choice and bid for a hospital bed therein. If the bid is accepted by the hospital, the patient may then solicit bids from physicians qualified to perform the procedure at the hospital. In this manner, a patient or payor may be able to perfect the provision of the medical service by modularizing the components of the service and acquiring each component separately by means of bidding.

Current insurance reimbursement policies and practice frequently cause delay in payment for the provider of the medical services. The cost of the “float” is currently carried by the medical service provider and inflates the cost of providing medical services. Similarly, the provider must bear a portion of the cost of negotiating the presently complex and cumbersome contractual relationship between providers and insurers. In accordance with the present invention, the parties to the bidding transaction may specify payment policy. For example, the provider may require a 10% deposit at the time the bidding closes with an additional 90% due prior to the scheduled date of service. In this way, costly last minute cancellations can be minimized. In this regard, it may also be desirable to establish the buyer's ability to pay the bid price for a medical service by searching a variety of databases containing member credit information prior to accepting the bid. Such search engines are well known in the prior art and may be linked to the system 16 electronically.

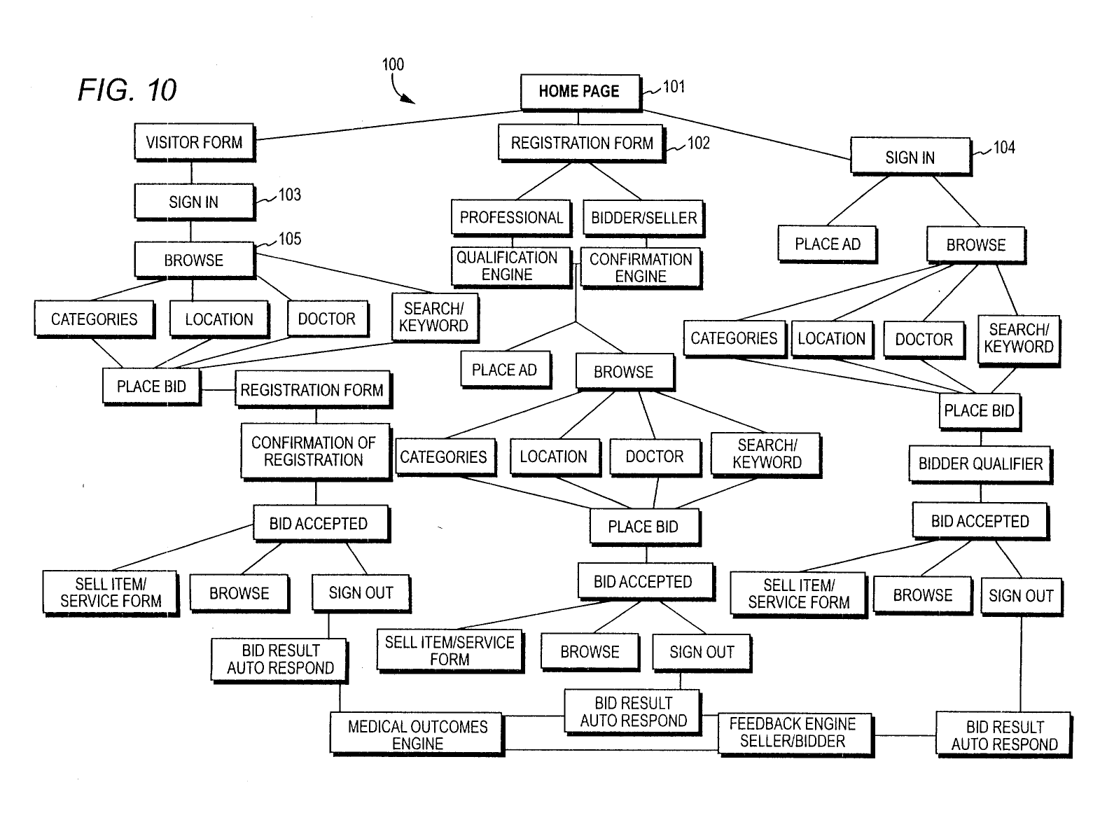

FIG. 10 shows an hierarchical diagram of linked Internet “web” pages, illustrated as labeled blocks 100, for an example medical transaction system “web-site” provided by medical transaction system 16. Any person having a computer with an Internet connection and a conventional “browser” program can obtain access to the medical transaction system web-site as provided by the present invention. In this example, conventional HTML document “web” pages 100 are distributed via the Internet by transaction system 16. Hyper-text links (not shown) on the web pages allow an on-line “visitor” to view further web pages provided by medical transaction system 16 (as indicated by the connecting lines between labeled blocks 100). The various web-pages may be accessed, for example, by prospective bidders and service providers via the hyper-text links for obtaining specific information or performing a particular function. For example, an on-line “visitor” to the transaction system web site may begin an on-line session by receiving a “home page” 101 from which the visitor can access and view other “linked” pages for participating on line in selected transactions and related activities such as: registering via an on-line registration form (102), identification as a registered user via “sign in” pages (103,104), browsing for specific information (105), etc.

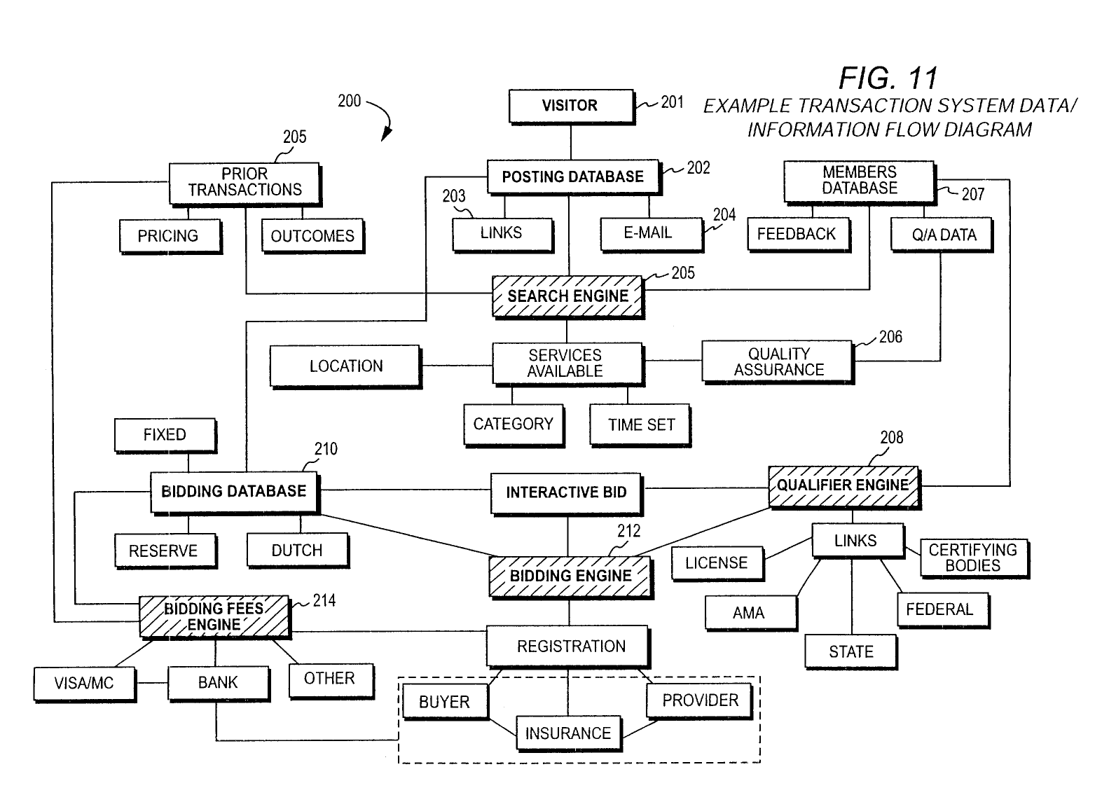

FIG. 11 shows a type of general data/information flow diagram 200 for the auction transaction system of the present invention for illustrating example functions available to an on-line visitor 201 upon accessing the medical transaction web-site. An on-line visitor, such as for example, a prospective bidder, service buyer (e.g. insurance company) or a provider of medical services, first encounters one or more on-line registration forms upon entering the web site, which must be completed before proceeding. The registration forms provided for a provider of services (who will also need to list their qualifications to provide such services) are different than for a buyer of services (who will need to establish credit worthiness and a certain threshold criteria and identification to make them an accreditable purchaser of services). This may be accomplished through the use of conventional on-line credit checking engines having links, for example, to VISA, Mastercard and other credit or banking institutions. A prospective purchaser of services may then enter a “posting” database page (202) where procedures for bidding are made available to bidders and providers can post their services and their specific requirements/conditions.

At the posting database page there are web page links 203 to individual provider web sites to further improve the depth of knowledge and qualifications of such provider. There is also provision for making an e-mail connection 204 with the proffered service providers if there are specific issues that need to be resolved, answered or negotiated between the bidder and the provider. Search engine 205 can search by categories, time, locations, and available services, as well as parameters that are linked to quality assurance. A quality assurance database 206 is linked to a provider member's database 207. Using this database, web pages are also provided for viewing comments and feedback associated with individual transaction and outcomes, as well as links to a software qualifier engine (authenticating engine) that evaluates each registered provider member through outside links to AMA, State Licensing, Federal Licensing, Hospital Privileges and certifying bodies.

Such multi-level confirmation to outside available database is done internally by transaction system 16 in the background through the qualifier engine. For example, system 16 performs a search in an outside Public domain database or subscribed databases using a registrant's name and license number. Confirmations are then displayed for the bidder/user of such services.

Upon registering a provider of proffered services lists his/her qualification, board certification and his/her hospital privileges. In the background, the qualifier engine 208 will reach out to existing databases in the network to determine if stated/listed qualifications of a particular service provider are confirmed and cross referenced on existing outside databases.

Subsequent bids on a given procedure are stored. There are various types of bidding process that may go on. They could be negotiated bids with counter offers. There could be a reserved bid where a provider lists his services with a hidden reserve price below which, until that price is reached, he is not obliged to consume the transaction and there is a Dutch bid in which a number of procedures or hospital beds can be listed at a given price and bidders bid at that price. If all the orders are filled they can voluntarily raise their price to secure a primary position in obtaining such limited services at the specified Dutch bid. In addition, there is a prior transaction database where assessment of similar procedures by similar providers can be traced historically. There is also a database for outcomes of such transactions in the feedback form.

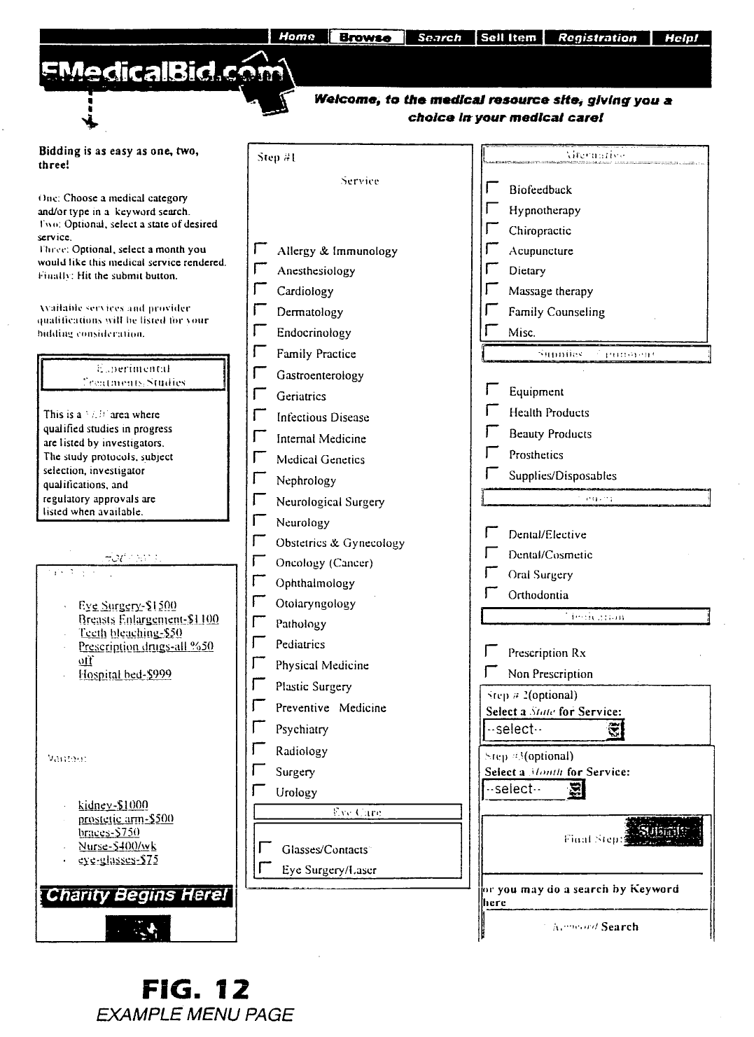

FIGS. 12 through 16 show bitmapped image screenshots of several exemplary web pages provided by an auction transaction system engine of the present invention. More specifically, FIGS. 12 through 16 illustrate example web pages for an example medical/health services auction site made publicly accessible on line (i.e., via the Internet) at an domain/address corresponding to “EmedicalBid.com”. FIG. 12 shows a bitmapped image screenshot of an example proffered services menu (“Browse”) page. In this example embodiment, the menu page includes lists of proffered medical services and products for selection by a prospective bidder. The menu page in this embodiment may also include a display section listing experimental treatments/studies where protocols, subject selection criterion, investigator qualifications and regulatory approvals are listed when available. In addition, the menu page in this embodiment may include user selection boxes for selecting a preferred location (e.g., by state) and a preferred time (e.g., by month) for the service to be performed. The menu page for the example embodiment may further include a display section listing “hot items” representing selected proffered services and/or medical products that are currently being offered at a low price representing a “good deal.” The menu page for the example embodiment may also include a display section for listing “wanted” items and/or services (i.e., desired items and/or services) along with a proffered price posted, for example, by a recent visitor to the web site.

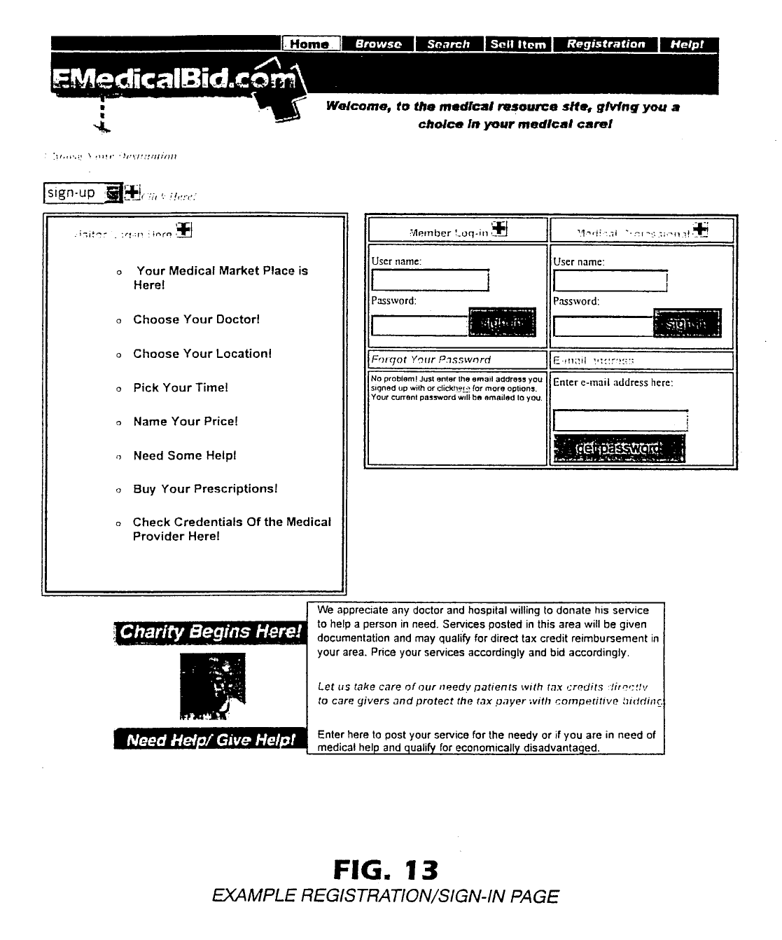

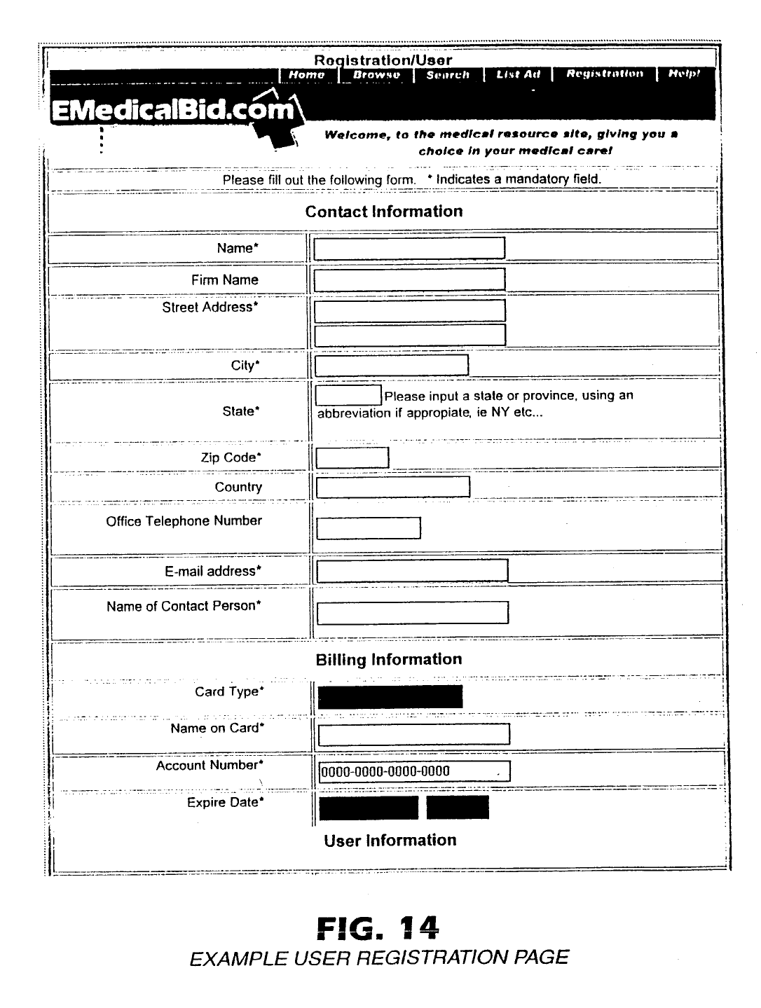

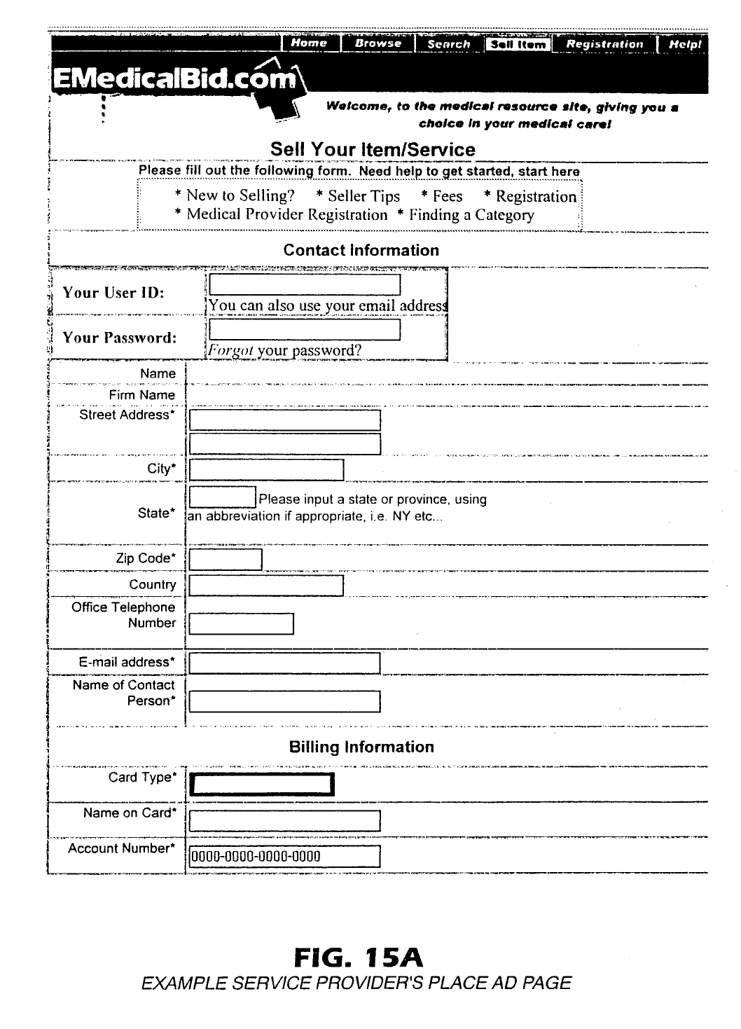

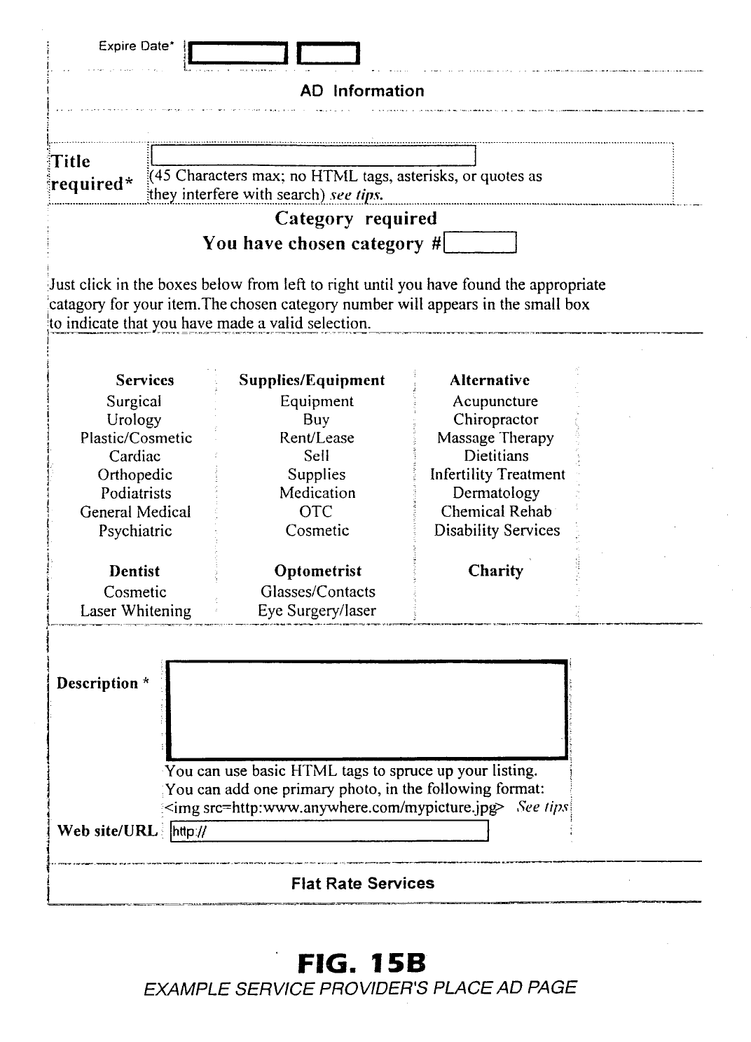

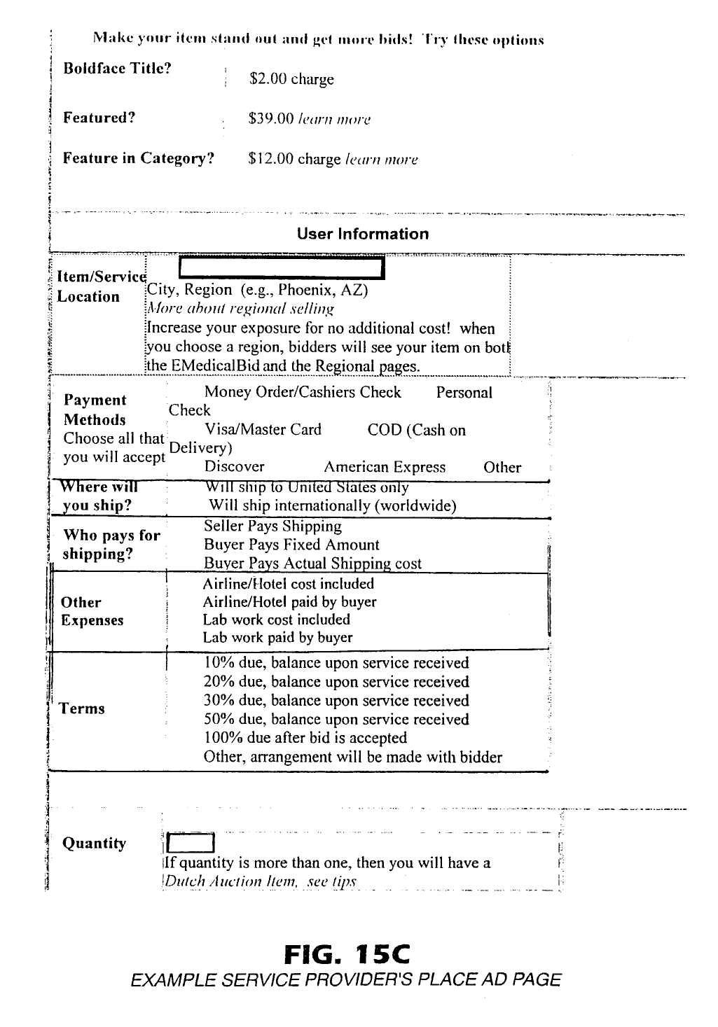

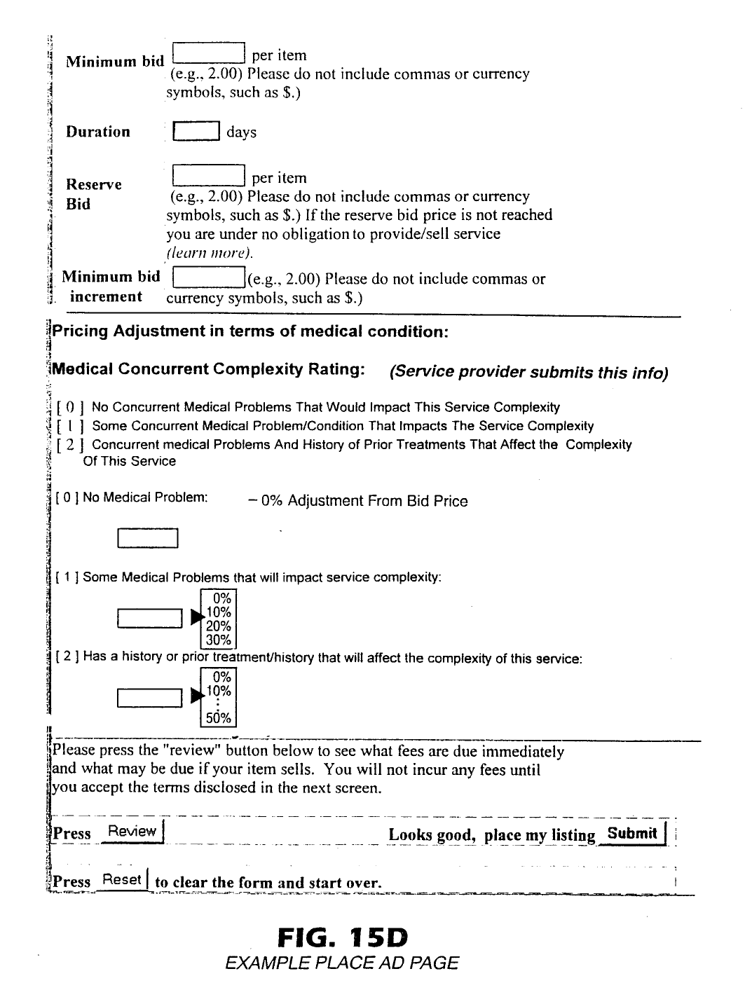

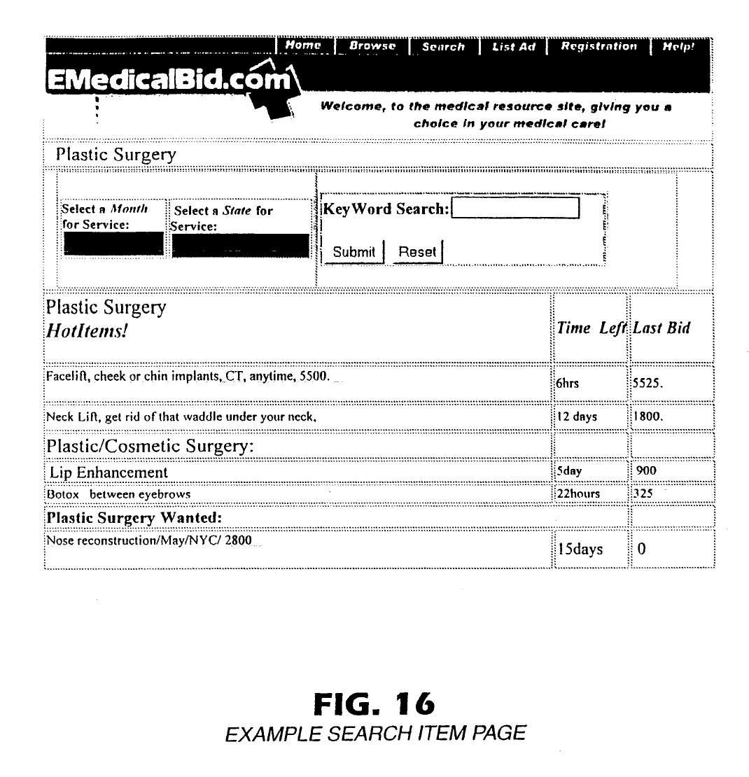

FIG. 13 shows a bitmapped image screenshot of an example visitor “Log-in” web page provided on line for registered users of the medical transaction system of the present invention. FIG. 14 shows a bitmapped image screenshot of an example visitor “Registration” web page provided on line. FIGS. 15A through 15D show bitmapped image screenshots of an example “Place-ad” page provided to a registered service provider and FIG. 16 shows a bitmapped image screenshot of an example “Search-item” page provided to a prospective patient/bidder.

The on-line transaction system of the present invention also provides an arrangement for handling and providing bid price modifications and variable pricing schemes to accommodate, for example, unanticipated changes in rendered medical procedures and medical procedures of various levels of complexity. For example, a gall bladder removal operation performed on a healthy person vs. a patient with a potentially affecting concurrent condition or illness (such as diabetes, hypertension or obesity) may require a different degree or level of care or even a different type of medical service or treatment than originally bid upon. For example, one type of service/treatment may be provided on an out-patient basis and another may require use of an acute care facility. Consequently, there is a need to disclose to a provider of proffered medical services at least some personal medical information concerning a prospective patient so that an equitable price or an adjustment to an offered price for proffered services can be made in the case where it is determined that unanticipated different or additional medical services must be rendered.

The need for a disclosure of personal medical information by a prospective patient or bidder can potentially pose a problem in an “anonymous” on-line bidding context since the personal privacy interests of prospective patients/ bidders must somehow be protected. Although such information may significantly affect the ultimate cost of a proffered service, a prospective patient/bidder should not be required to disclose on line detailed personal medical information before an actual patient/physician relationship is established. As an effective solution to this problem, the on-line transaction system of the present invention uses an on-line medical “complexity rating” that allows a bidder to communicate to a proffered service provider a scale value that is at least somewhat indicative of the degree to which undisclosed pre-existing/concurrent personal medical conditions may affect the proffered service. In an example embodiment, a prospective patient may select a complexity rating which best describes his/her concurrent medical condition or medical history from an on-line list provided by the transaction system. Once a patient/physician relationship is actually established, the selected complexity rating is later used by the transaction system in computing an adjustment to the bid price. The amount of the adjustment is subject to a complexity rating of the patient by the service provider after evaluating the patient.

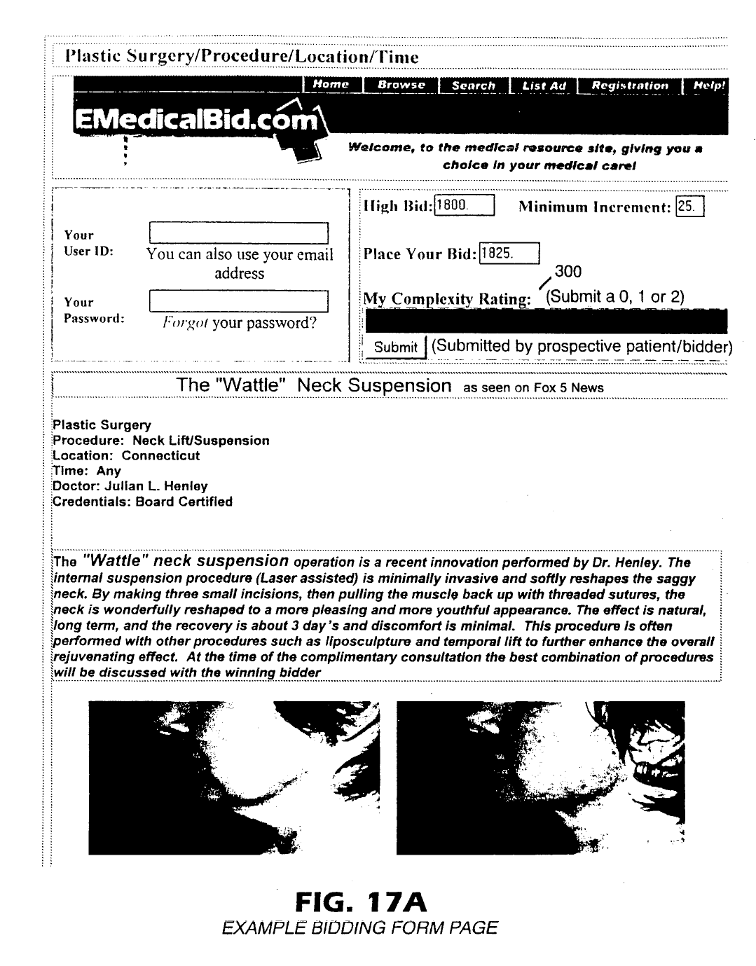

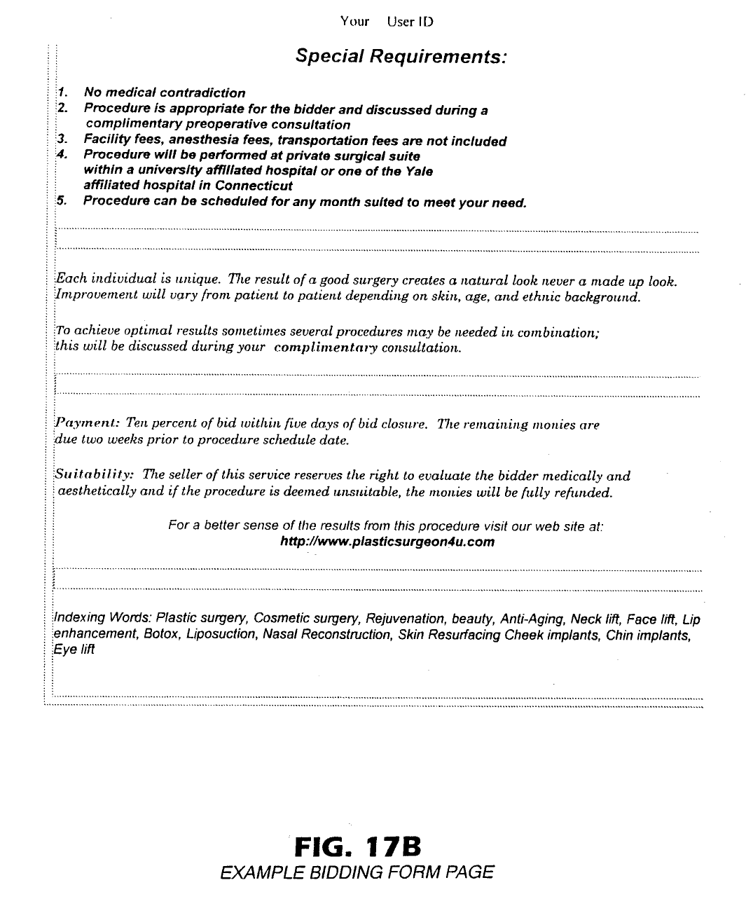

For example, using a limited scale of values from zero to two, a medical complexity rating scale value of “0” might be used to define the medical situation of a standard healthy patient with no known concurrent medical conditions or problems (indicating no potentially complicating factors to treatment); a scale value of “1” might be used to define the medical situation of a patient with at least one concurrent medical condition or other associated medical problems (indicating some degree of medical complexity and potentially complicating factors to treatment); and, a scale value of “2” might be used to define the medical situation of a patient with multiple concurrent medical conditions, problems or history of prior failed treatments (indicating a medically complex situation with multiple factors contributing to the performance of the proffered service). A prospective patient/bidder, after reviewing the on-line complexity rating definitions, then selects and submits a complexity rating selection value—preferably along with his/her bid during the on-line bidding process. FIGS. 17A and 17B show a bit-mapped screen display of an example “bidding form” web page provided to an on-line bidder. In this example, complexity rating input box (300) is provided for selecting and submitting a complexity rating scale value.

At the time of registering with transaction system 16 and placing an on-line solicitation for offers to bid on a proffered service, a service provider may submit information relating to an amount or percentage of bid price adjustment to be made as a function of the increase (or decrease) in complexity of rendering a proffered service, based on the same medical concurrent complexity rating scale. FIG. 15D shows a bit-mapped screen display of a portion of an example place-ad/registration form web page provided to an on-line service provider. In this example, a portion of the provided web page place-ad/registration form includes a “Medical Concurrent Complexity Rating” scale definition (400) that is displayed, along with web page input boxes (401, 402, 403) below it, for selecting and submitting bid price adjustments to be made based on the complexity rating scale.

For example, if a provider lists a gallbladder operation where he can have an incremental increase depending on his fee and listed in the bid depending on the associated complexity. He can have a current status that is about 20% to 30% increase for level 1 complexity and possible a 40% increase for level 2 complexity. Level 1 complexity would be an associated medical condition that could impact the complexity of the given procedure. Such conditions could be diabetes, hypertension, bleeding disorders, cardiac disease or basically anyone who is taking other medical for other chronic medical conditions. This would be voluntarily listed as a category 1 of complexity. There is another level of complexity that would constitute a category 2 that not only involves specific conditions that would complicate a given treatment, but also a history of previous treatments, failed or successful for a given conditions.

An another example of such procedural “complexity” would be if a patient has undergone four rhinoplasties in the past and is shopping for the fifth. Obviously, this involves previous failed treatment. The area is full of scar tissue and a revision scar rhinoplasty is certainly not a virgin rhinoplasty. At the same token, the patient will submit voluntarily, his own assessment of complexity. In the feedback that the provider of services learns about the patient, he/she will list the complexity divergence score that after medical evaluation to describe whether the patient correctly described their level of complexity. This would constitute the market force to maintain honest communication yet, at the same time, disclose no specifics about a particular condition and, in the absence of specific information, privacy issues are not encountered. In this fashion, the patient voluntarily assesses his or her own level of complexity and communicates that to the provider. The provider has an automatic pricing adjustment, if he chooses, or he may choose to have it at the same price but at least the complexity issues are not negatively impacting the conditional bid transaction.

The condition aspect remains in force because the provider of services, or physician, has the ultimate liability to assess whether the given procedure is medically indicated even though the patient may have bid for it. he has to have the option to decline if he deems it an unnecessary risk to the patient's life or not medically indicated for the condition the patient is seeking. By the same token, the patient is protected that, in the event an alternative procedure is required, the patient will have an opportunity to receive that alternate procedure at the same price he bid for with the lesser procedure, with a relative value scale factor adjustment for the more complex procedure. This protects the pricing the patient has pursued and prevents the clinicians from unnecessarily “upcoding” the complexity or negotiating a new deal once the patient is in their office. CPT coding for procedures I already establish where it's a database of a description and codes. A standard word search can be utilized to locate the appropriate codes to describe a given procedure.

Once a patient/physician relationship is established between a bidder and a service provider (assuming, for example, the provider/physician has physically examined and evaluated the patient), the service provider/physician similarly submits a complexity rating scale value on line to the transaction system based on an assessment of the patient (patient evaluation feedback). The transaction system then uses the respective complexity rating scale values submitted by both the patient/bidder and the service provider/physician to compute a “complexity divergence” score. This value may be based, for example, on the difference between the complexity rating scale value submitted by the patient and the complexity rating scale value submitted by the provider. The transaction system may also compute a cumulative divergence score based, for example, on a running average of complexity divergence scores associated with a particular patient over a series of separate medical transactions.

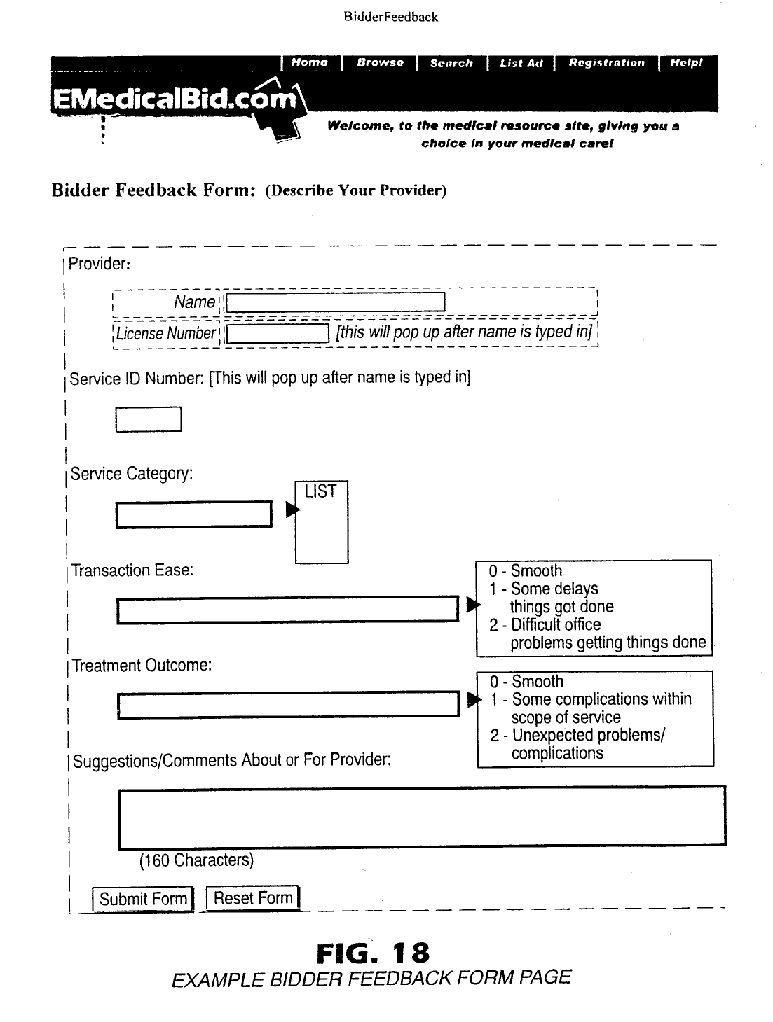

Transaction system 16 also provides various web page based on-line “feedback” mechanisms for both the patient and the provider. For example, FIG. 18 shows a bit-mapped screen display of an example Bidder Feedback form web page provided on line to a registered bidder. The example form includes drop-down input selection boxes for allowing a registered bidder to select various predefined descriptions of the bidder's perceived quality of service provided by a particular service provider. For example, one or more an input/selection boxes are provided for identifying: the particular service provider used, the service category involved, the ease/difficulty of conducting the particular transaction (transaction ease), the outcome of the treatment (treatment outcome) and providing suggestions/comments about or for the service provider.

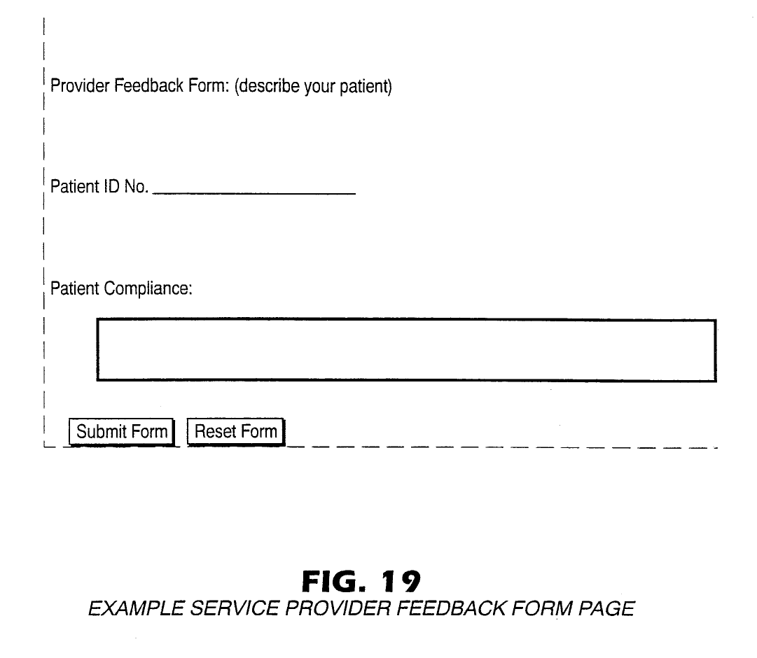

Provisions are also made for allowing a service provider to provide comments/feedback regarding a particular patient. For example, FIG. 19 shows a bit-mapped screen display of an example Provider's Feedback Form web page provided on line to a registered service provider. Using a “patient's compliance” input box displayed on a web page provided by the transaction system to a registered service provider, the provider may submit feedback to the transaction system such as, for example, various comments/information regarding a particular patient's ability to follow instructions and take appropriate medication.

The auction transaction system of the present invention may also be set up to implement a “complexity and divergence” scoring arrangement for computing increases (or decreases) to auctioned service prices. The following example situation illustrates the operation of the complexity and divergence scoring arrangement in accordance with the present invention: A patient shopping for a rhinoplasty bids for a rhinoplasty from a skilled practitioner and represents himself as a complexity level value of “zero.” However, during the personal consultation with the physician, it is revealed that the patient has had three fractures and four previous operations. Consequently, the patient has a fair amount of pre-existing scarring, the complexity of the surgery is greater and the chances of getting good results are borderline. The physician now has a medical obligation to inform the patient of the increased complexity of the surgery. In this example, a divergence factor value of at least “two” would be considered to exist and the physician would have the choice of not performing the procedure (if he feels the risks are too high). If an understanding with the bidder can be reached, the physician may decide to perform the procedure but rate it at a higher level of complexity. A new price would then be computed by the transaction system using published CPT codes and a “relative value” multiplier. For example, if the simple procedure is conventionally performed at a nominal base price of $3000, but the existence of two levels of complexity imply a 40% increase to the nominal base price, then the new price computed by the transaction system will reflect compliance with the relative value multiplier scale and will be automatically increased in price by the appropriate percentage.

Procedural CPT codes are a set of complex codes developed to help insurance companies code medical procedures in their attempt to standardize reimbursements. Transaction system 16 may incorporate a CPT coding/search engine that provides the CPT code number associated with a particular medical procedure. The proffered service provider may optionally list relevant CPT codes that describe the procedure he/she is putting up for bid. In a contract, for example, the provider of services agrees to follow conventional published “relative value” guidelines in the event that the bidder medically ultimately needs a related CPT code medical service instead of the proffered service upon which the bid was based. (There are presently several publishers, for example, McGraw Hill, which publish “relative value scales” that attempt to standardize the relative multiplier factors of one CPT code against another.) For example, a hernia operation may be associated a multiplier of 1.2 relative to a tonsillectomy. This feature is useful for handling the situation where a bidder for medical services bids for a procedure of lower complexity and is a holder of a contingent bid, and at the time of the consultation and finalization it is perceived through the medical practitioner that a patient has asked for one operation but actually to treat his condition, needs another.

For example, in order to set guide lines for such further negotiation on pricing and to protect the bidder from having the health provider inequitably increase the price for a related procedure, the provider of services is bound by his/her contract to utilize the published relative value multipliers. If the bidder requires another medical service that is related but of different complexity, the bidder has the option to accept the negotiated price of a different CPT coded procedure, but is bound by the relative value multipliers against the same price that was bid on the lesser procedure. Such an arrangement protects the bidder from the dilemma of contingent bids if he/she requires another medical service than what he/she bids for, and it protects him/her from upper pricing related service by the provider. By the same token, it allows the provider to judiciously use his medical knowledge and perform appropriate procedures on his patient under guidelines of current medical standards and not be subject to bids that the patients may have chosen. Accordingly, the disclosed example arrangement of the present invention offers both the flexibility of judicious medical choices, yet protects the consumer from inequitable fluctuations of the bid price.

In the above described EmedicalBid.com web site example embodiment, the services auction transaction system engine for the on-line transaction system of the present invention provides a medical services “exchange” for public arbitration of medical service prices in a manner somewhat analogous to that by which the New York Stock Exchange arbitrates stock prices. Essentially, it provides an efficient method and means to enable public bidding for specified health services. As previously mentioned above, the bidding engine of the present invention effectively allows a service provider to place “service options” for a specific health/medical service up for auction on line in a manner analogous to a purchase of stock options that have a time value (i.e., must be exercised within a specified period of time) and a specified strike price in the stock market. For example, using the present invention a medical service option for a tonsillectomy to be performed on a patient having no other associated complications might be proffered for auction by a physician with the stipulation that the procedure will be performed if the proper medical indications have been met and an agreement is reached between the patient and the physician as to the appropriateness of the procedure.

Along the same lines, it may also be useful and desirable to provide an “option” to purchase various health services according to certain predetermined associated terms at a discount. For example, a physician may not wish to disclose or set a specific price for performing an specific medical procedure/service but may be willing to offer a $300 discount off of any services to patients willing to provide immediate payment for services, if such an “option” is exercised within a predetermined period. Such an arrangement may be accommodated, for example, by making a discount coupon option or the like available. Accordingly, in addition to the various features and embodiments of the example services auction transaction system described above, the on-line transaction system arrangement of the present invention further includes distinct auction transaction engine components for the purpose of supporting a separate on-line auction (i.e., separate from the professional services auction) for the auctioning of discount coupons or analogous options/vehicles to purchase a service at a discount from one or more service providers.

In an example embodiment, discount coupons that are redeemable against the customary fees charged for a proffered professional service are made available for auction on line by one or more service providers via a supplemental on-line auction transaction system/component (referred to hereinafter as a discount coupon auction transaction system). In one preferred embodiment, the discount coupon auction transaction system shares at least some database resources with the above described professional services auction transaction system and may be implemented using either the same or distinct hardware resources. Preferably, the on-line discount coupon auction transaction system is provided using separate and distinct web pages but it may be linked (i.e., made accessible) from the professional services auction transaction system web-site pages.

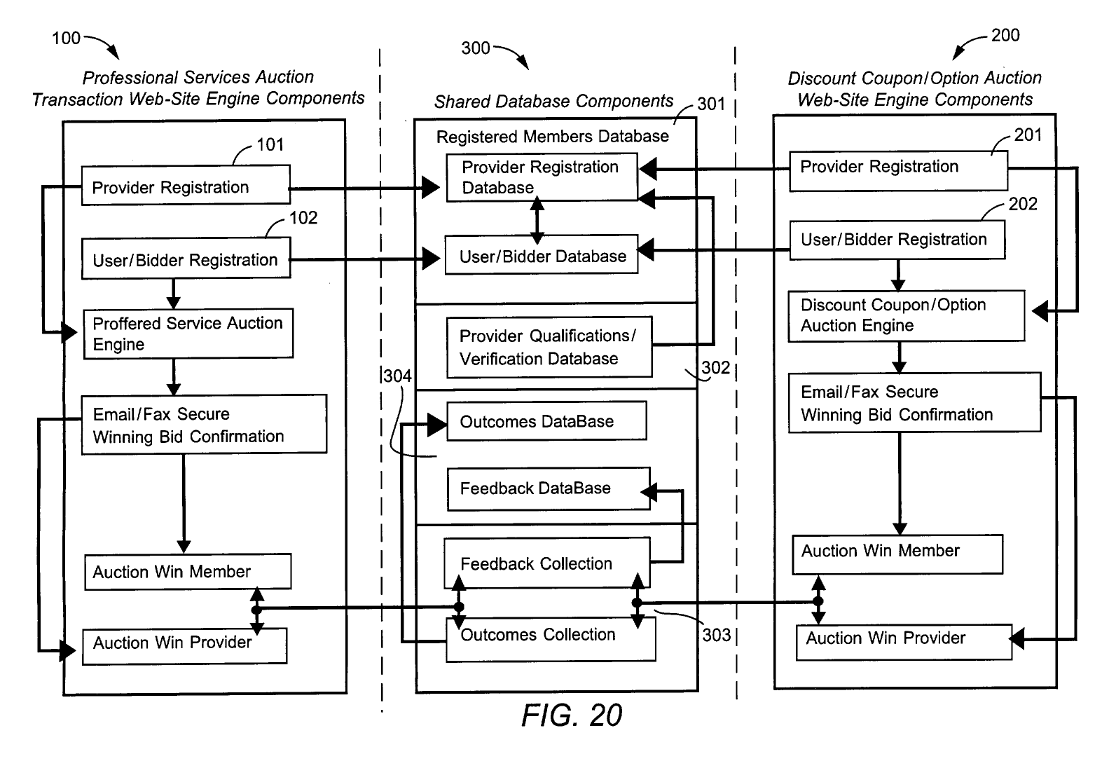

In FIG. 20, functional block diagrams are used to illustrate information flow and example software operational components for implementing an on-line transaction system having a professional services auction transaction system web-site engine/components 100, a separate discount coupon auction transaction system web-site engine/components 200 and shared database components 300.

As illustrated by FIG. 20, service provider member registration information 101, 201 and user/bidder member registration information 102, 202 acquired via either web-site engine is stored within a single registered members database 301 that is commonly accessible and shared between the two distinct auction transaction system web-sites. Other shared components may include, for example, a Provider qualification/verification information database 302, member feedback and procedure outcome collection engines 303, and member feedback and procedure outcome databases 304. The shared database and engine components 300 are made accessible to both the discount coupon auction transaction system web-site engine 100 and the professional services auction transaction web-site engine 200. In this manner, only a single set of information databases need be maintained for both auction transaction systems. A registered bidder using the discount coupon auction transaction system web-site and a registered bidder using the professional services auction transaction system web-site would each be able to have access to information concerning a particular service provider via the common shared provider qualification/verification, procedure outcome and member feedback databases 302, 304.

With the multiple auction transaction system arrangement of the present invention, a professional service provider has the option of listing proffered services for bids via the professional services auction transaction system web site and additionally providing discounts for specific services via the discount coupon auction transaction site—or alternatively only listing specific services via the discount coupon auction transaction site (for instance if it does not wish to disclose a set pricing profile or disclose specific prices for certain services). For example, a professional medical service provider may decide that it is in its best interest to only solicit bids for a discount coupon applicable toward its fee for performing a specific procedure (e.g., a $100 discount coupon for an outpatient tonsillectomy) rather than posting specific fees and minimum bidding prices for one or more proffered procedures on the professional services auction transaction web-site. In the above context, a discount coupon of the present invention may be considered as a subset of an option with negotiation of fees (i.e., a service discount coupon). One example may be an option to purchase medical services at a specified cash discount within a specified period of time, contingent on medical appropriateness.

Such discount coupons offered on line by a medical service provider may prove to be very useful and highly desirable to persons bidding on-line for medical services who prefer to pay a medical service provider in cash, such as uninsured persons or, for example, medical patients subject to an insurance policy wherein the initial health expense for the year is to be paid out-of-pocket. Such potential patients are usually highly motivated to obtain services from qualified providers at the best possible price. Alternatively, an insurance carrier itself may also bid for cash discount coupons for particular services on behalf of its insured policy holder beneficiaries, with the agreement that the face value of the discount coupon obtained via winning bid or sale can be applied against the customary fee charged for the described professional services. A discount coupon may also be used as currency for providing prompt payment for specific products/services or a portion thereof.

When using the discount coupon auction transaction system web-site, a service provider may place one or more discount coupons having a particular set face value into auction on line for a predetermined period and, if desired, require a specific minimum bidding price for each coupon. For example, a $100 discount coupon redeemable toward the service fee for performing a tonsillectomy may be placed in auction on line by the proffering service provider at a minimum bidding threshold of $10. The particular discount coupon(s) offered may be applicable toward something as simple as an office consultation visit or as involved as a complex surgical procedure. At the termination of the period for accepting on-line bids (i.e., a predetermined open interactive on-line auctioning period), a winning bid (e.g., the highest bid during the auctioning period) for the $100 discount coupon may, for example, turn out to be $14. If the bidder makes an immediate full payment of the winning bid (or pays in full within a specified predetermined time limit), he obtains a printable coupon on line with his name and/or an identifying ID number printed on the coupon. The service provider is also provided with a copy of the sold coupon (e.g., via email) identifying and verifying the name of the winning bidder. The discount coupon (or option) may also be made transferable to another by direct agreement of the specific provider. The discount coupon may have a predetermined time stipulation associated with it within which it must be redeemed (e.g., the coupon may be valid only for the next 3-6 months during which the specified proffered health service must be obtained). Another example stipulation of this discount coupon for service arrangement could be that the bid coupon holder is permitted to seek health services from only the specified service provider who listed the coupon.

A protective policy may also be implemented for larger (i.e., more expensive) medical procedures. For example, in the event a coupon recipient obtains inappropriate services, he may be able to return the coupon to the medical coupon site and be reimbursed a percentage of his bid. Such an arrangement will not protect the coupon recipient against any time expiration limitations, but may at least serve to protect against inappropriate medical choices, or bidding for the wrong procedure, or provide some protection in instances where an agreement between a patient and the health service provider can not be reached. The above discount coupon offering example is based on an agreement that full payment for the professional services shall be provided and at time of service or not longer than a stipulated time period (e.g., three days after the service has been rendered). If payment is not made within the stipulated time frame, the value of the coupon expires and the patient is liable for the full customary amount without the benefit of coupon face value discount. In this manner, the patient benefits from a negotiated lower price and the health care provider of the service benefits from a timely payment and a lower cost of collection for services rendered.

The transaction system of the present invention further includes a method and arrangement for implementing on line a person-to-person network marketing business model for rewarding existing member professional service providers for the recruiting of prospective new service provider members and for training them in the use of the on-line auction transaction systems described herein. This aspect of the present invention promotes the creation and development of a network of service provider members (and to a lesser degree a network of bidders/purchasers) for the recruitment and training of additional service providers and purchasers. In an example implementation of this aspect of the invention, a member service provider (e.g., a member physician) who is knowledgeable and trained in the use and operation of the auction transaction system solicits or initiates meetings with other prospective users of the system (e.g., other physicians in the community) during which he will have an opportunity to introduce, demonstrate and train them in use of the system. (Explanatory manuals and materials may be made available either on line or by other means to facilitate such a presentation either individually or in a group.)

For example, a recruiting service provider participating in the network marketing may be a member physician who has an identifying provider ID number that was initially provided by the on-line auction transaction system upon registration. For this example, he is designated as a “level-1” recruiting director. In accordance with the network marketing process, he may recruit and sign on another physician who in turn is designated as a “level-2” recruiting director. This level-2 recruiting director has the potential to further recruit and train a “level-3” director, and so on. Upon initial recruitment, which may be performed via email, the prospective new member is directed to a specific web page associated with the provider ID number of the level-1 recruiting director that is maintained on line by the transaction system for signing-up new members. Upon registering, the new member receives an ID number that is associated to the ID of the level-1 director who recruited him. At this point, if the new member also wishes to participate in recruiting others, he will be designated as a level-2 recruiting director. In a similar fashion, as a level-2 recruiting director, he may then further recruit and train another who may in turn may become a level-3 recruiting director. The identifying member ID number for this level-3 recruiting director will likewise be associated with the level-2 recruiting director and with the initial level-1 recruiting director.

By using the above procedure (or one similar), the auction transaction system keeps track of the chain of recruitment. This chain of recruitment information may then be utilized for implementing a predetermined reward or incentive program such as, for example, a monetary award schedule wherein a portion of revenues obtained from completed on-line auction transactions is paid out to one or more member recruiting directors belonging to the chain of recruitment of the member service/product provider associated with each particular transaction. The rational for such an arrangement being that it provides an incentive for registered service provider members to enhance market penetration through acts of recruiting, training and teaching others in the use of the on-line auction transaction system. For example, if the winning bid for a $100 discount coupon proffered in an on-line auction was $14, then a predetermined percentage of the winning bid price, e.g., $4, is allocated for rewarding one or more of the recruiting directors in the chain of directors responsible for recruiting the service provider member participating in the transaction. In this example, a predetermined portion of the $4 reward allocation, e.g., $2.50, may go to a level-3 director that actually participated in the transaction. A smaller portion, e.g., $1, is awarded to the level-2 recruiting director and a still smaller portion, e.g.,$0.50, is rewarded to the level-1 recruiting director.

This above example monetary reward scheme (or one similar) for promoting a network of marketing personnel is intended to be implemented automatically by the on-line auction transaction system and may be integrated into the control software of the on-line auction transaction system. The same or a similar arrangement of rewarding users for recruitment and training of new users may also be implemented for different types of system users (e.g., registered bidders) using a similar award scheme integrated within the transaction system control software. For example, if a new bidder/user of the on-line auction transaction system who purchased discount coupons or professional services was recruited through the efforts of a particular registered member, then that registered member may be identified via his membership ID number and may be rewarded accordingly in some fashion. In this manner, an efficient market networking business model for recruiting new users and registering new service provider members may be implemented using the same hardware infrastructure that supports the existing on-line auction transaction system.

As disclosed herein, the present invention can produce a lowering in the cost for provision of medical services in at least the following ways: 1) bringing market forces to bear on the price of medical services will produce a downward pressure on the cost of such services; 2) medical resources at a given service facility may be allocated more efficiently, thereby reducing costly “down time.” Third, the on-line transaction system of the present invention can reduce a service provider's non-productive costs associated with carrying a monetary “float” and reduce or eliminate the cost of entering into complex agreements with insurers. In addition, savings made possible through the present invention may enable a greater share of limited healthcare market dollars to be spent on delivering needed health care rather than on contracts, appeals and marketing expenses.

The skilled artisan will appreciate that the apparatus and method of the present invention may easily be adapted for use in other fields of professional service such as the provision of legal and accounting services, and/or wherever it may be desirable to permit market forces to impact the transactional cost of providing services. While particular embodiments of the present invention have been illustrated and described, it will be obvious to those skilled in the art that various other changes and modifications can be made without departing from the spirit and scope of the invention. The appended claims are therefore intended to cover all such changes and modifications.

What is claimed is:

1. An on-line auction transaction system implemented over a publicly accessible digital communications network comprising a web-page server computer system connected to a publicly accessible communications network for maintaining one or more web pages, said web-page server computer system comprising:
a product/services auction transaction web-site engine that co-operates with a discount coupon/options auction transaction web-site engine, wherein the product/services auction transaction web-site engine and the discount coupon/options auction transaction web-site engine both have access to a shared database of stored information maintained by said computer system.

2. The on-line auction transaction system of claim 1 wherein said shared database is a provider qualifications database.

3. The on-line auction transaction system of claim 1 wherein said shared database is a provider verification database.

4. The on-line auction transaction system of claim 1 wherein said shared database is a provider qualifications/verification database.

5. The on-line auction transaction system of claim 1 wherein said shared database is a feedback database.

6. The on-line auction transaction system of claim 1 wherein said shared database is an outcomes database.

7. An on-line auction transaction system implemented over a publicly accessible digital communications network comprising a web-page server computer system connected to a publicly accessible communications network for maintaining one or more web pages, said web-page server computer system comprising:
a product/services auction transaction web-site engine;
a discount coupon/options auction transaction web-site engine; and
at least one transaction system database maintained by the web-page server computer system to which access is shared by both the product/services auction transaction web-site engine and the discount coupon/options auction transaction web-site engine.

8. An on-line auction transaction system as set forth in claim 7 further comprising a plurality of shared transaction system databases to which access is shared by both the product/services auction transaction web-site engine and the discount coupon/options auction transaction web-site engine.

9. An on-line auction transaction system as set forth in claim 8 wherein at least one shared database is used to store provider qualifications information.

10. An on-line auction transaction system as set forth in claim 8 wherein at least one shared database is used to store provider verification information.

11. An on-line auction transaction system as set forth in claim 8 wherein at least one shared database is used to store user feedback information.

12. An on-line auction transaction system as set forth in claim 8 wherein at least one shared database is used to store outcome information.

13. An on-line computerized method for auctioning a discount coupon associated with a particular service proffered by a service provider, said discount coupon being redeemable against fees/charges for a particular service provider's services, comprising the steps of:
posting on line, over a digital communications network, at least one discount coupon redeemable against fees/charges charged by a particular service provider for providing a proffered service, wherein the discount coupon has a predetermined minimum bidding price;
receiving on-line bids for the discount coupon as proffered by prospective customers of such service provider; and
awarding the discount coupon on line to a particular winning bidder by transmitting a bid award verification receipt to a winning bidder or set-fee purchaser over the digital communications network, wherein the discount coupon is awarded to an on-line bidder posting a highest bid within a predetermined time period after posting the coupon on line for bidding.

14. The method of claim 13 wherein said service proffered by a service provider is a medical service.

15. In an on-line auction transaction system implemented over a publicly accessible communications network such as the Internet, said transaction system comprising a web-site server computer system and a plurality of databases containing information relating to conducting auction transactions, an on-line computerized method for auctioning product/services and discount coupons/options that are redeemable against fees charged for said products/services, comprising the steps of:
providing an on line product/services auction transaction web-site implemented on said web-site server computer system using a first software auction transaction engine; and
providing an on line discount coupon/options auction transaction web-site implemented on said web-site server computer system using a second software auction transaction engine;
wherein at least one database containing information relating to conducting auction transactions is common to both the first and second web-site engine.

16. An on-line professional services auction transaction system implemented over a publicly accessible digital communications network, said system enabling professional service providers to make available for purchase via auctioning on line a service option to purchase a specified proffered service at a predetermined discount, said system comprising:
a computer system connected to a publicly accessible communications network;
a computer-readable storage device connected to said computer system for maintaining one or more information databases, including at least one database containing verified information concerning the professional services provider's qualifications to provide the specified professional services; and
a program for controlling said computer system;
wherein the program is operable for causing the computer system to: (a) receive an on-line offer from a professional services provider to place said option up for auction on line over the publicly accessible digital communications network; and (b) post an offer on line to sell the option via a web site for hosting the on-line auction that is accessible by prospective buyers of the specified professional service via said publicly accessible digital communications network.

17. The on-line auction transaction system of claim 16, wherein the service option is a discount coupon, said discount coupon being applicable toward fees charged by the professional services provider for performing the specified professional service.

18. The auction transaction system of claim 16, wherein the program is further operable for causing the computer system to authenticate the professional services provider's qualifications to provide the proffered professional service by searching one or more information databases containing verified information concerning the professional services provider's qualifications.

19. An on-line auction transaction system comprising at least one web-site server computer, said system implemented over a publicly accessible digital communications network, said web-site server computer programmed to:
assign an ID number/code to each new member upon registration, wherein said ID number/code acts at least in part as a reference to a particular previously registered member; and
apportion a predetermined portion of a winning bid amount associated with an on-line auction transaction among registered members who are referenced by an ID number/code assigned to at least one party of said on-line auction transaction.

20. In an on-line auction transaction system implemented over a publicly accessible communications network such as the Internet, said system providing on-line interactive auctioning of professional services and/or products proffered by one or more registered service provider members, a method for providing incentive to registered service provider members to recruit and/or train new prospective service provider members, comprising the steps performed by a computer of:
assigning a unique ID number to each new service/product provider member upon registration, wherein said ID number acts at least in part as a reference to one or more particular previously registered members for having recruited and/or trained said new service/product provider member in the use of the on-line auction transaction system; and
apportioning a predetermined percentage of a winning bid amount associated with an on-line auction transaction among one or more registered members who are referenced by an ID number/code assigned to at least one party of said on-line auction transaction.

21. An on-line computerized method for auctioning a service option for purchasing services proffered by a service provider at a discount, said service option being exercisable for a particular service provider's services, comprising the steps of:
posting on line, over a digital communications network, an option to purchase services proffered by a particular service provider at a predetermined discount, wherein the option has a predetermined minimum bidding price;
receiving on-line bids for the option as proffered by prospective patients of said service provider; and
awarding the option on line to a particular winning bidder by transmitting a bid award verification receipt to a winning bidder over the digital communications network, wherein the option is awarded to an on-line bidder posting a highest bid within a predetermined time period after posting the option on line for bidding.

22. The method of claim 21 wherein the service option is a discount coupon.

23. The method of claim 21 wherein the proffered service is a medical procedure/service.
